(19) United States
(12) Patent Application Publication
(10) Pub. No.: US 2007/0248276 A1
(43) Pub. Date: Oct. 25, 2007

(54) Quantization Table Producing Device, Quantization Table Producing Method, Quantization Table Producing Program, Image Compression Device, Image Compression Method and Image Compression Program

(76) Inventors: Yoichiro Yahata, Tenri-shi (JP); Atsushi Ono, Nara-shi (JP)

Correspondence Address: BIRCH STEWART KOLASCH & BIRCH, PO BOX 747, FALLS CHURCH, VA, 22040-0747, US

(21) Appl. No.: 11/629,499

(22) PCT Filed: Jun. 8, 2005
(86) PCT No.: PCT/JP05/10467

§ 371 Date: Dec. 14, 2006

(30) Foreign Application Priority Data
Jun. 15, 2004 (JP) 2004-177134
Jun. 15, 2004 (JP) 2004-177302

(51) Int. Cl. G06K 9/36

(52) U.S. Cl. 382/251

(57) ABSTRACT

An image compression device includes a quantization table storing portion storing a first quantization table and a second quantization table prepared by adjusting the first quantization table with a spatial filter, a frequency converter performing frequency conversion on input image data, a quantizer quantizing the data subjected to the frequency conversion, using the second quantization table, an encoder encoding the quantized data, and an output portion outputting the encoded data and the first quantization table in a correlated fashion.

### TECHNICAL FIELD

The present invention relates to a quantization table producing device, a quantization table producing method, a quantization table producing program, an image compression device, an image compression method and an image compression program, and particularly to a quantization table producing device, a quantization table producing method, quantization table producing program, an image compression device, an image compression method and an image compression program that use a compression manner using different quantization tables for compression and decompression, respectively.

### BACKGROUND ART

Image compression devices based on the JPEG scheme have been available. The JPEG scheme is a technique for compressing still images, and is established set by Joint Photographic Coding Experts Group. The JPEG technique is disclosed, e.g., by Hiroshi Yasuda and Hirotomo Watanabe “Fundamentals, Basic Principle and Application of Digital Image Compression”, Nikkei BP Shuppan Center, Chapter 3 Encoding (JPEG) of Color Still Image, pp. 97-111 (e.g., non-patent reference 1).

The above JPEG scheme exhibits outstanding performance in connection with a relationship between image quality and data size as well as a compression processing quantity, but causes block noises and/or mosquito noises when a compression rate is increase, e.g., to 1/50 for reducing a data size. The block noises are block-like (e.g., 8×8 pixels per unit) distortions caused in an image obtained by decompressing compressed data. The mosquito noises appear just like a large swarm of mosquitoes, and occur on images containing high-range components and edge portions (e.g., character portions).

For reducing the above mosquito noises, there is a technique that uses different quantization tables (or different quantization steps) in quantization for compression and dequantization for decompression, respectively. This technique is disclosed, e.g., in Japanese Patent Laying-Open Nos. 9-224246 and 10-191391 (e.g., patent references 1 and 2, respectively).

A spatial filtering processing such as smoothing or sharpening may be performed. This technique is disclosed by Tatsuo Higuchi and Masayuki Kawamata, “MATLAB-compatible Digital Signal Processing”, Shokodo, Mar. 27, 2000, Chapter 13 (Two-dimensional Digital Filter), pp. 206-219 (e.g., nonpatent reference 2). In this prior art, the spatial filtering processing is effected on image data as processing independent of compression processing, Therefore, the filtering processing and the compression processing must be executed independently of each other, which results in a problem that a load on processing becomes large.

In view of the above, such a technique has been known that achieves the filtering processing such as smoothing or sharpening by using different quantization tables for quantization in compressing processing and for dequantization in decompressing processing, respectively. This technique has been disclosed in Japanese Patent Laying-Open Nos. 4-315371 and 2001-358948 (e.g., patent references 3 and 4). In the prior arts that execute the filtering processing by using the different quantization tables for the quantization in compressing processing and for the dequantization in decompressing processing, respectively, it is necessary for each filtering processing to predetermine a set of the quantization tables that are used for the quantization in compressing processing and for the dequantization in decompressing processing, respectively. This results in a problem that such sets of the quantization tables cannot be determined without difficulty.

Patent Document 1: Japanese Patent Laying-Open No. 9-224246

Patent Document 2: Japanese Patent Laying-Open No. 10-191391

Patent Document 3: Japanese Patent Laying-Open No. 4-315371

Patent Document 4: Japanese Patent Laying-Open No. 2001-358948

Nonpatent Document 1: Hiroshi Yasuda and Hirotomo Watanabe “Fundamentals, Basic Principle and Application of Digital Image Compression”, Nikkei BP Shuppan Center, Chapter 3 Encoding (JPEG) of Color Still Image, pp. 97-111

Nonpatent Document 2: Tatsuo Higuchi and Masayuki Kawamata, “MATLAB-compatible Digital Signal Processing”, Shokodo, Mar. 27, 2000, Chapter 13 (Two-dimensional Digital Filter), pp. 206-219

### DISCLOSURE OF THE INVENTION

Problems to be Solved by the Invention

The invention has been made for overcoming the above problems, and an object of the invention is to provide a quantization table producing device, a quantization table producing method and a quantization table producing program that can readily produce a quantization table for use in quantization of compression processing and a quantization table for use in dequantization of decompression processing.

Another object of the invention is to provide an image compression device, an image compression method and image compression program that can improve quality of decompressed images.

Still another object of the invention is to provide a quantization table producing device that can produce a quantization table or a dequantization table that can reduce noises due to quantization processing.

Means for Solving the Problems

According to a further aspect of the invention, an image compression device includes a quantization table storing portion storing a first quantization table and a second quantization table prepared by adjusting the first quantization table with a spatial filter; a frequency converter performing frequency conversion on input image data; a quantizer quantizing the data subjected to the frequency conversion, using the second quantization table; an encoder encoding the quantized data; and an output portion outputting the encoded data and the first quantization table in a correlated fashion.

According to the invention, the input image data is subjected to the frequency conversion, the frequency-converted data is quantized with the second quantization table prepared by adjusting the first quantization table with the spatial filter, the quantized data is encoded, and the encoded data and the first quantization table are output in the correlated fashion. Therefore, it is possible to provide the image compression device that can improve quality of decompressed images.

According to a further aspect of the invention, an image compression device includes a quantization table storing portion storing a first quantization table and a third quantization table prepared by adjusting the first quantization table with a spatial filter; a frequency converter performing frequency conversion on input image data; a quantizer quantizing the data subjected to the frequency conversion, using the first quantization table; an encoder encoding the quantized data; and an output portion outputting the encoded data and the third quantization table in a correlated fashion.

According to the invention, the input image data is subjected to the frequency conversion, the frequency-converted data is quantized with the first quantization table, the quantized data is encoded, and the encoded data and the third quantization table prepared by adjusting with the spatial filter are output in the correlated fashion. Therefore, it is possible to provide the image compression device that can improve quality of decompressed images.

According to still another aspect of the invention, an image compression device includes a quantization table storing portion (120B) storing a first quantization table; a frequency converter performing frequency conversion on input image data; a quantizer quantizing the frequency-converted data, using the first quantization table; an encoder encoding the quantized data; an adjuster producing a third quantization table by adjusting the first quantization table used for quantization, using a spatial filter; and an output portion outputting the encoded data and the third quantization table in a correlated fashion.

According to the invention, the frequency conversion is effected on the input image data, the frequency-converted data is quantized using the first quantization table, the quantized data is encoded, and the encoded data and the third quantization table prepared by adjusting the first quantization table with the spatial filter are output in the correlated fashion. Therefore, it is possible to provide the image compression device that can improve quality of decompressed images.

According to a further aspect of the invention, an image compression device includes a quantization table storing portion storing a second quantization table prepared by adjusting a first quantization table with a spatial filter; a frequency converter performing frequency conversion on input image data; a quantizer quantizing the frequency-converted data, using the second quantization table; an adjuster producing a fourth quantization table by adjusting the second quantization table used for quantization, using the spatial filter; an encoder encoding the quantized data; and an output portion outputting the encoded data and the fourth quantization table in a correlated fashion.

According to the invention, the frequency conversion is effected on the input image data, the frequency-converted data is quantized using the second quantization table prepared by adjusting the first quantization table, using the spatial filter, the quantized data is encoded, and the encoded data and the fourth quantization table prepared by adjusting the second quantization table with the spatial filter are output in the correlated fashion. Therefore, it is possible to provide the image compression device that can improve quality of decompressed images.

A further another aspect of the invention, an image compression device includes a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; a quantization table storing portion storing a first quantization table and a second quantization table prepared by adjusting the first quantization table with a spatial filter, the stored second quantization table being applied to the quantizer; and a replacing portion replacing the second quantization table correlated with the encoded code data by the correlating portion with the stored first quantization table.

According to the invention, the quantization is performed using the second quantization table prepared by adjusting the first quantization table with the spatial filter. Since the second quantization table correlated with the encoded code data is replaced with the first quantization table, the data quantized using the second quantization table is dequantized using the first quantization table. Therefore, it is possible to reduce noises that occur during quantization of the encoded code data. Consequently, it is possible to provide the image compression device that can improve quality of decompressed images.

Preferably, the spatial filter is one of a smoothing filter for smoothing an image, a sharpening filter for sharpening, or an edge enhancing filter for enhancing an edge.

According to the invention, it is possible to provide the image compression device that can simultaneously execute the processing of smoothing, sharpening or edge enhancing by producing the quantization table for use in quantization or dequantization. In particular, when the smoothing filter is used, a quantization table or a dequantization table that can effectively remove noises such as mosquito distortions or the like caused by the quantization processing is produced. Therefore, it is possible to provide the image compression device that can reduce noises caused by the quantization processing.

According to a further aspect of the invention, an image compression device includes a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; a quantization table storing portion storing a first quantization table and a third quantization table prepared by adjusting the first quantization table with a spatial filter, the stored first quantization table being applied to the quantizer; and a replacing portion replacing the first quantization table correlated with the encoded code data by the correlating portion with a third quantization table.

According to the invention, since the first quantization table is used for quantization, and the first quantization table correlated with the encoded code data is replaced with the third quantization table, the dequantization is performed with the third quantization table that is produced by adjusting the first quantization table, using the spatial table. Therefore, it is possible to reduce noises that occur when quantizing the encoded code data. Consequently, it is possible to provide the image compression device that can improve quality of decompressed images.

Preferably, the spatial filter is one of a smoothing filter for smoothing an image, a sharpening filter for sharpening, or an edge enhancing filter for enhancing an edge.

According to a further aspect of the invention, an image compression device includes a quantization table storing portion storing a first quantization table; a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer, the first quantization table being given to the quantizer; an adjuster producing a third quantization table by adjusting the first quantization table used for quantization, using a spatial filter; and a replacing portion replacing the first quantization table correlated with the encoded code data by the correlating portion with the produced third quantization table.

According to the invention, since the first quantization table is used for quantization, and the first quantization table correlated with the encoded code data is replaced with the third quantization table, the dequantization is performed with the third quantization table produced by adjusting the first quantization table, using the spatial table. Therefore, it is possible to reduce noises that occur when quantizing the encoded code data. Consequently, it is possible to provide the image compression device that can improve quality of decompressed images.

Preferably, the spatial filter is one of a smoothing filter for smoothing an image, a sharpening filter for sharpening, or an edge enhancing filter for enhancing an edge.

Preferably, the image compression device further includes a conversion table producing portion producing a conversion table by performing frequency conversion on the spatial filter, and the adjuster performs arithmetic on corresponding elements in the quantization table and the produced conversion table according to a predetermined rule.

According to a further aspect of the invention, an image compression device includes a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; a quantization table storing portion storing a second quantization table prepared by adjusting the first quantization table with a spatial filter, the stored second quantization table being applied to the quantizer; an adjuster producing a fourth quantization table by adjusting the second quantization table used for quantization, using a spatial filter; and a replacing portion replacing the second quantization table correlated with the encoded code data by the correlating portion with a fourth quantization table.

According to the invention, the quantization is performed with the second quantization table prepared by adjusting the first quantization table with the spatial filter. The second quantization table correlated with the encoded code data is replaced with the fourth quantization table that is produced by adjusting the second quantization table used for quantization, using the spatial filter. Therefore, it is possible to reduce noises that occur when quantizing the encoded code data. Consequently, it is possible to provide the image compression device that can improve quality of decompressed images.

Preferably, the spatial filter is one of a smoothing filter for smoothing an image, a sharpening filter for sharpening, or an edge enhancing filter for enhancing an edge.

Preferably, the image compression device further includes a conversion table producing portion producing a conversion table by performing frequency conversion on the spatial filter, and the adjuster performs arithmetic on corresponding elements in the quantization table and the produced conversion table according to a predetermined rule.

According to a further aspect of the invention, an image compression method is executed by an image compression device including a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; and a quantization table storing portion storing a first quantization table and a second quantization table prepared by adjusting the first quantization table with a spatial filter; and the method includes the steps of: giving the stored second quantization table to the quantizer; and replacing the second quantization table correlated with the encoded code data by the correlating portion with the stored first quantization table.

According to the invention, it is possible to provide an image compression method that can improve quality of decompressed images.

According to a further aspect of the invention, an image compression method is executed by an image compression device including a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; and a quantization table storing portion storing a first quantization table and a third quantization table prepared by adjusting the first quantization table with a spatial filter; and the method includes the steps of: giving the stored first quantization table to the quantizer; and replacing the first quantization table correlated with the encoded code data by the correlating portion with the stored third quantization table.

According to the invention, it is possible to provide an image compression method that can improve quality of decompressed images.

According to a further aspect of the invention, an image compression method is executed by an image compression device including a quantization table storing portion storing a first quantization table; a frequency converter performing frequency conversion on input image data; a quantizer quantizing the frequency-converted data, using a quantization table given to the quantizer; an encoder encoding the quantized data; and a correlating portion correlating the encoded code data with the quantization table used by the quantizer; and the method includes the steps of: giving the first quantization table to the quantizer; producing a third quantization table by adjusting the first quantization table used for quantization, using a spatial filter; and replacing the first quantization table correlated with the encoded code data by the correlating portion with the produced third quantization table.

According to the invention, it is possible to provide an image compression method that can improve quality of decompressed images.

According to a further aspect of the invention, an image compression method is executed by an image compression device including a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; and a quantization table storing portion storing a second quantization table prepared by adjusting the first quantization table, using the spatial filter; and the method includes the steps of: giving the stored second quantization table to the quantizer; producing a fourth quantization table by adjusting the second quantization table used for quantization, using the spatial filter; and replacing the second quantization table correlated with the encoded code data by the correlating portion with the produced fourth quantization table.

According to the invention, it is possible to provide an image compression method that can improve quality of decompressed images.

According to a further aspect, the invention provides an image compression program product for execution by a computer including a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; and a quantization table storing portion storing a first quantization table and a second quantization table prepared by adjusting the first quantization table with a spatial filter; and the image compression program product causing a computer to execute the steps of: giving the stored second quantization table to the quantizer; and replacing the second quantization table correlated with the encoded code data by the correlating portion with the stored first quantization table.

According to the invention, it is possible to provide an image compression program product that can improve quality of decompressed images.

According to a further aspect, the invention provides an image compression program product for execution by a computer including a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; and a quantization table storing portion storing a first quantization table and a third quantization table prepared by adjusting the first quantization table with a spatial filter; and the image compression program product causing a computer to execute the steps of: giving the stored first quantization table to the quantizer; and replacing the first quantization table correlated with the encoded code data by the correlating portion with the stored third quantization table.

According to the invention, it is possible to provide an image compression program product that can improve quality of decompressed images.

According to a further aspect, the invention provides an image compression program product for execution by a computer including a quantization table storing portion storing a first quantization table; a frequency converter performing frequency conversion on input image data; a quantizer quantizing the frequency-converted data, using a quantization table given to the quantizer; an encoder encoding the quantized data; and a correlating portion correlating the encoded code data with the quantization table used by the quantizer; and the image compression program product causing a computer to execute the steps of: giving the first quantization table to the quantizer; producing a third quantization table by adjusting the first quantization table used for quantization, using a spatial filter; and replacing the first quantization table correlated with the encoded code data by the correlating portion with the produced third quantization table.

According to the invention, it is possible to provide an image compression program product that can improve quality of decompressed images.

According to a further aspect, the invention provides an image compression program product for execution by a computer including a frequency converter performing frequency conversion on input image data; a quantizer quantizing the frequency-converted data, using a quantization table given to the quantizer; an encoder encoding the quantized data; a correlating portion correlating the encoded code data with the quantization table used by the quantizer; and a quantization table storing portion storing a second quantization table prepared by adjusting the first quantization table, using the spatial filter; and the image compression program product causing a computer to execute the steps of giving the stored second quantization table to the quantizer; producing a fourth quantization table by adjusting the second quantization table used for quantization, using the spatial filter; and replacing the second quantization table correlated with the encoded code data by the correlating portion with the produced fourth quantization table.

According to the invention, it is possible to provide an image compression program product that can improve quality of decompressed images.

For achieving the above objects, an aspect of the invention provides a quantization table producing device including a quantization table obtaining portion obtaining a quantization table and outputting the obtained quantization table as a quantization table to be used for dequantization; a spatial filter obtaining portion obtaining a spatial filter; and an adjuster producing a quantization table to be used for quantization by adjusting the obtained quantization table, using the obtained spatial filter.

According to the invention, the quantization table is obtained, and is output as a quantization table to be used for dequantization. Using the spatial filter, the quantization table is adjusted to produce the quantization table for use in quantization, and the produced quantization table is output. By determining the value of the number (nine) of elements in the spatial filter, it is possible to determine the quantization table for quantization and a dequantization table fore dequantization. Accordingly, it is possible to provide the quantization table producing device that can readily set the quantization table for use in quantization in compression processing and the quantization table for use in dequantization in decompression processing.

Preferably, the spatial filter is one of a smoothing filter for smoothing an image, a sharpening filter for sharpening, or an edge enhancing filter for enhancing an edge.

According to the invention, the quantization table or the dequantization table can be readily produced. In particular, when the smoothing filter is used, a quantization table or a dequantization table that can effectively remove noises such as mosquito distortions or the like caused by the quantization processing is produced. Therefore, it is possible to provide the quantization table producing device capable of producing the quantization table or the dequantization table that can reduce noises caused by the quantization processing.

Preferably, the device further includes a conversion table producing portion producing a conversion table by performing frequency conversion on the spatial filter, and the adjuster performs arithmetic on corresponding elements in the quantization table and the produced conversion table according to a predetermined rule.

According to a further aspect of the invention, a quantization table producing device includes a quantization table obtaining portion obtaining a quantization table and outputting the obtained quantization table as a quantization table to be used for quantization; a spatial filter obtaining portion obtaining a spatial filter; and an adjuster producing a quantization table to be used for dequantization by adjusting the obtained quantization table, using the obtained spatial filter.

According to the invention, the quantization table is obtained, and is output as a quantization table to be used for quantization. The quantization table is adjusted to produce the quantization table for use in dequantization, and the produced quantization table is output. Accordingly, it is possible to provide the quantization table producing device that can readily set the quantization table for use in quantization in compression processing and the quantization table for use in dequantization in decompression processing.

Preferably, the spatial filter is one of a smoothing filter for smoothing an image, a sharpening filter for sharpening, or an edge enhancing filter for enhancing an edge.

Preferably, the device further includes a conversion table producing portion producing a conversion table by performing frequency conversion on the spatial filter, and the adjuster performs arithmetic on corresponding elements in the quantization table and the produced conversion table according to a predetermined rule.

According to a further aspect of the invention, a quantization table producing device includes a spatial filter obtaining portion obtaining a spatial filter; and an adjuster producing a quantization table to be used for dequantization by adjusting the quantization table used for quantization, using the obtained spatial filter.

According to the invention, the quantization table used for quantization is adjusted using the obtained spatial filter, and thereby the quantization table for used in dequantization is produced and output. Accordingly, it is possible to provide the quantization table producing device that can readily set the quantization table for use in quantization in compression processing and the quantization table for use in dequantization in decompression processing.

Preferably, the spatial filter is one of a smoothing filter for smoothing an image, a sharpening filter for sharpening, or an edge enhancing filter for enhancing an edge.

Preferably, the image compression device further includes a conversion table producing portion producing a conversion table by performing frequency conversion on the spatial filter, and the adjuster performs arithmetic on corresponding elements in the quantization table and the produced conversion table according to a predetermined rule.

According to a further aspect of the invention, a quantization table producing device includes a quantization table obtaining portion obtaining a quantization table; a spatial filter obtaining portion obtaining a spatial filter; a first adjuster producing a quantization table to be used for quantization by adjusting the obtained quantization table, using the obtained spatial filter; and a second adjuster producing a quantization table to be used for dequantization by adjusting the quantization table used for quantization, using the obtained spatial filter.

According to the invention, the quantization table is adjusted using the spatial filter, and thereby the quantization table for use in quantization is produced and output. Meanwhile, the quantization table used for quantization is adjusted using the obtained spatial filter, and thereby the quantization table for use in dequantization is produced and output. Accordingly, it is possible to provide the quantization table producing device that can readily set the quantization table for use in quantization in compression processing and the quantization table for use in dequantization in decompression processing.

Preferably, the spatial filter is one of a smoothing filter for smoothing an image, a sharpening filter for sharpening, or an edge enhancing filter for enhancing an edge.

Preferably, the device further includes a conversion table producing portion producing a conversion table by performing frequency conversion on the spatial filter, and the first and second adjusters perform arithmetic on corresponding elements in the quantization table and the produced conversion table according to a predetermined rule.

According to a further aspect of the invention, an image compression device includes a quantization table obtaining portion obtaining a quantization table and outputting the obtained quantization table as a quantization table to be used for dequantization; a spatial filter obtaining portion obtaining a spatial filter; an adjuster producing a quantization table to be used for quantization by adjusting the obtained quantization table, using the obtained spatial filter; a frequency converter performing frequency conversion on input image data; a quantizer receiving the quantization table to be used for quantization, and quantizing the frequency-converted data, using the received quantization table; an encoder encoding the quantized data; and an output portion receiving the quantization table to be used for dequantization, outputting the encoded code data and the received quantization table to be used for dequantization in a correlated fashion.

According to the invention, the frequency conversion is effected on the image data, the frequency-converted data is quantized using the quantization table to be used for quantization, and the quantized data is encoded. The encoded data and the quantization table to be used for dequantization are correlated and output. At least one of the quantization table to be used for quantization and the quantization table to be used for dequantization is adjusted and produced using the spatial filter. Therefore, the image data obtained by decompressing the code data provides an image that undergoes processing similar to image processing using the spatial filter. Consequently, it is possible to provide the image compression device that can improve quality of decompressed images.

According to a further aspect of the invention, an image compression device includes a quantization table obtaining portion obtaining a quantization table and outputting the obtained quantization table as a quantization table to be used for quantization; a spatial filter obtaining portion obtaining a spatial filter; an adjuster producing a quantization table to be used for dequantization by adjusting the obtained quantization table, using the obtained spatial filter; a frequency converter performing frequency conversion on input image data; a quantizer receiving the quantization table to be used for quantization, and quantizing the frequency-converted data, using the received quantization table; an encoder encoding the quantized data; and an output portion receiving the quantization table to be used for dequantization, outputting the encoded code data and the received quantization table to be used for dequantization in a correlated fashion.

According to the invention, the frequency conversion is effected on the image data, the frequency-converted data is quantized using the quantization table to be used for quantization, and the quantized data is encoded. The encoded data and the quantization table to be used for dequantization are correlated and output. At least one of the quantization table to be used for quantization and the quantization table to be used for dequantization is adjusted and produced using the spatial filter. Therefore, the image data obtained by decompressing the code data provides an image that undergoes processing similar to image processing using the spatial filter. Consequently, it is possible to provide the image compression device that can improve quality of decompressed images.

According to a further aspect of the invention, an image compression device includes a spatial filter obtaining portion obtaining a spatial filter; an adjuster producing a quantization table to be used for dequantization by adjusting the quantization table used for quantization, using the obtained spatial filter; a frequency converter performing frequency conversion on input image data; a quantizer receiving the quantization table to be used for quantization, and quantizing the frequency-converted data, using the received quantization table; an encoder encoding the quantized data; and an output portion receiving the quantization table to be used for dequantization, outputting the encoded code data and the received quantization table to be used for dequantization in a correlated fashion.

According to the invention, the frequency conversion is effected on the image data, the frequency-converted data is quantized using the quantization table to be used for quantization, and the quantized data is encoded. The encoded data and the quantization table to be used for dequantization are correlated and output. At least one of the quantization table to be used for quantization and the quantization table to be used for dequantization is adjusted and produced using the spatial filter. Therefore, the image data obtained by decompressing the code data provides an image that undergoes processing similar to image processing using the spatial filter. Consequently, it is possible to provide the image compression device that can improve quality of decompressed images.

According to a further aspect of the invention, an image compression device includes a quantization table obtaining portion obtaining a quantization table; a spatial filter obtaining portion obtaining a spatial filter; a first adjuster producing a quantization table to be used for quantization by adjusting the obtained quantization table, using the obtained spatial filter; a second adjuster producing a quantization table to be used for dequantization by adjusting the quantization table used for quantization with the obtained spatial filter; a frequency converter performing frequency conversion on input image data; a quantizer receiving the quantization table to be used for quantization, and quantizing the frequency-converted data, using the received quantization table; an encoder encoding the quantized data; and an output portion receiving the quantization table to be used for dequantization, and outputting the encoded code data and the received quantization table to be used for dequantization in a correlated fashion.

According to the invention, the frequency conversion is effected on the image data, the frequency-converted data is quantized using the quantization table to be used for quantization, and the quantized data is encoded. The encoded data and the quantization table to be used for dequantization are correlated and output. At least one of the quantization table to be used for quantization and the quantization table to be used for dequantization is adjusted and produced using the spatial filter. Therefore, the image data obtained by decompressing the code data provides an image that undergoes processing similar to image processing using the spatial filter. Consequently, it is possible to provide the image compression device that can improve quality of decompressed images.

According to a further aspect of the invention, a quantization table producing method includes the steps of: obtaining a quantization table and outputting the quantization table as a quantization table to be used for dequantization; obtaining a spatial filter; and producing a quantization table to be used for quantization by adjusting the obtained quantization table, using the obtained spatial filter.

According to the invention, it is possible to provide the quantization table producing method that can readily set the quantization table for use in quantization in compression processing and the quantization table for use in dequantization in decompression processing.

According to a further aspect of the invention, a quantization table producing method includes the steps of: obtaining a quantization table and outputting the quantization table as a quantization table to be used for quantization; obtaining a spatial filter; and producing a quantization table to be used for dequantization by adjusting the obtained quantization table, using the obtained spatial filter.

According to the invention, it is possible to provide the quantization table producing method that can readily set the quantization table for use in quantization in compression processing and the quantization table for use in dequantization in decompression processing.

According to a further aspect of the invention, a quantization table producing method includes the steps of obtaining a spatial filter; and producing a quantization table to be used for dequantization by adjusting a quantization table used for quantization, using the obtained spatial filter

According to the invention, it is possible to provide the quantization table producing method that can readily set the quantization table for use in quantization in compression processing and the quantization table for use in dequantization in decompression processing.

According to a further aspect of the invention, a quantization table producing method includes the steps of: obtaining a quantization table; obtaining a spatial filter; producing a quantization table to be used for quantization by adjusting the obtained quantization table, using the obtained spatial filter; and producing a quantization table to be used for dequantization by adjusting a quantization table to be used for quantization, using the obtained spatial filter.

According to the invention, it is possible to provide the quantization table producing method that can readily set the quantization table for use in quantization in compression processing and the quantization table for use in dequantization in decompression processing.

According to a further aspect of the invention, a quantization table producing program product causes a computer to execute the steps of: obtaining a quantization table and outputting the quantization table as a quantization table to be used for dequantization; obtaining a spatial filter; and producing a quantization table to be used for quantization by adjusting the obtained quantization table, using the obtained spatial filter.

According to the invention, it is possible to provide the quantization table producing program that can readily set the quantization table for use in quantization in compression processing and the quantization table for use in dequantization in decompression processing.

According to a further aspect of the invention, a quantization table producing program product causes a computer to execute the steps of: obtaining a quantization table and outputting the quantization table as a quantization table to be used for quantization; obtaining a spatial filter; and producing a quantization table to be used for dequantization by adjusting the obtained quantization table, using the obtained spatial filter.

According to the invention, it is possible to provide the quantization table producing program that can readily set the quantization table for use in quantization in compression processing and the quantization table for use in dequantization in decompression processing.

According to a further aspect of the invention, a quantization table producing program product causes a computer to execute the steps of: obtaining a spatial filter; and producing a quantization table to be used for dequantization by adjusting a quantization table used for quantization, using the obtained spatial filter.

According to the invention, it is possible to provide the quantization table producing program that can readily set the quantization table for use in quantization in compression processing and the quantization table for use in dequantization in decompression processing.

According to a further aspect of the invention, a quantization table producing program product causes a computer to execute the steps of: obtaining a quantization table; obtaining a spatial filter; producing a quantization table to be used for quantization by adjusting the obtained quantization table, using the obtained spatial filter; and producing a quantization table to be used for dequantization by adjusting a quantization table to be used for quantization, using the obtained spatial filter.

According to the invention, it is possible to provide the quantization table producing program product that can readily set the quantization table for use in quantization in compression processing and the quantization table for use in dequantization in decompression processing.

### BRIEF DESCRIPTION OF THE DRAWINGS

FIG. 1 is a functional block diagram illustrating a schematic structure of an image compression device according to a first embodiment of the invention.

FIG. 2 is a flowchart illustrating flow of image compression processing executed by the image compression device of the first embodiment.

FIG. 3 is a flowchart illustrating quantization table obtaining processing executed by the image compression device of the first embodiment.

FIG. 4 illustrates an example of a spatial filter.

FIG. 5 shows an example of a conversion table produced by frequency conversion of the spatial filter 11 (M=3) illustrated in FIG. 4.

FIG. 6 illustrates a luminance component table in a default quantization table of a JPEG scheme.

FIG. 7 illustrates an example of a second quantization table calculated from a first quantization table and a conversion table.

FIG. 8 is a functional block diagram illustrating a schematic structure of an image compression device according to a second embodiment.

FIG. 9 is a flowchart illustrating flow of image compression processing executed by the image compression device of the second embodiment.

FIG. 10 is a flowchart illustrating flow of quantization table obtaining processing executed by the image compression device of the second embodiment.

FIG. 11 illustrates an example of a third quantization table calculated from a first quantization table and a conversion table.

FIG. 12 is a functional block diagram illustrating a schematic structure of an image compression device according to a third embodiment.

FIG. 13 is a functional block diagram illustrating a schematic structure of an image compression device according to a fourth embodiment.

FIG. 14 is a flowchart illustrating flow of image compression processing executed by the image compression device of the fourth embodiment.

FIG. 15 is a flowchart illustrating flow of quantization table obtaining processing executed by the image compression device of the fourth embodiment.

FIG. 16 is a functional block diagram illustrating a schematic structure of an image compression/decompression device according to a fifth embodiment of the invention.

FIG. 17 is a functional block diagram illustrating a schematic structure of an image compression/decompression device according to a sixth embodiment of the invention.

FIG. 18 is a functional block diagram illustrating a schematic structure of an image compression/decompression device according to a seventh embodiment of the invention.

FIG. 19 is a functional block diagram illustrating a schematic structure of an image compression/decompression device according to an eighth embodiment of the invention.

FIG. 20 is a functional block diagram illustrating a schematic structure of an image compression device according to a ninth embodiment of the invention.

FIG. 21 is a flowchart illustrating flow of image compression processing executed by the image compression device of the ninth embodiment.

FIG. 22 is a flowchart illustrating flow of compression processing executed by the image compression device of the ninth embodiment.

FIG. 23 is a functional block diagram illustrating a schematic structure of an image compression device according to a tenth embodiment of the invention.

FIG. 24 is a flowchart illustrating flow of image compression processing executed by the image compression device of the tenth embodiment.

FIG. 25 is a functional block diagram illustrating a schematic structure of an image compression device according to an eleventh embodiment of the invention.

FIG. 26 is a functional block diagram illustrating a schematic structure of an image compression device according to a twelfth embodiment of the invention.

FIG. 27 is a flowchart illustrating flow of image compression processing executed by the image compression device of the twelfth embodiment.

### DESCRIPTION OF THE REFERENCE SIGNS

100, 100A, 100B, 100C, 10000, 10000A, 10000B, 10000C image compression device, 101 frequency converter, 103 quantizer, 105 entropy encoder, 107, 107A, 107B output portion, 110, 110A, 110B, 110C, 1110, 1110A, 1110B, 1110C quantization table producing portion, 111, 111A, 111B quantization table obtaining portion, 113, 113A adjuster, 113B first adjuster, 115 spatial filter obtaining portion, 117 conversion table producing portion, 119 second adjuster, 130 image compressing portion, 140, 140A, 140B, 140C quantization table producing portion, 200, 200A, 200B, 200C image compression/decompression device, 210 image decompressing portion, 211 entropy decoder, 213 dequantizer, 215 inverse frequency converter, 107, 1107A, 1107B, 1107C replacing portion.

### BEST MODES FOR CARRYING OUT THE INVENTION

Embodiments of the invention will now be described with reference to the drawings. In the following description, the same parts bear the same reference numbers and the same names, and achieve the same functions. Therefore, description thereof is not repeated.

### First Embodiment

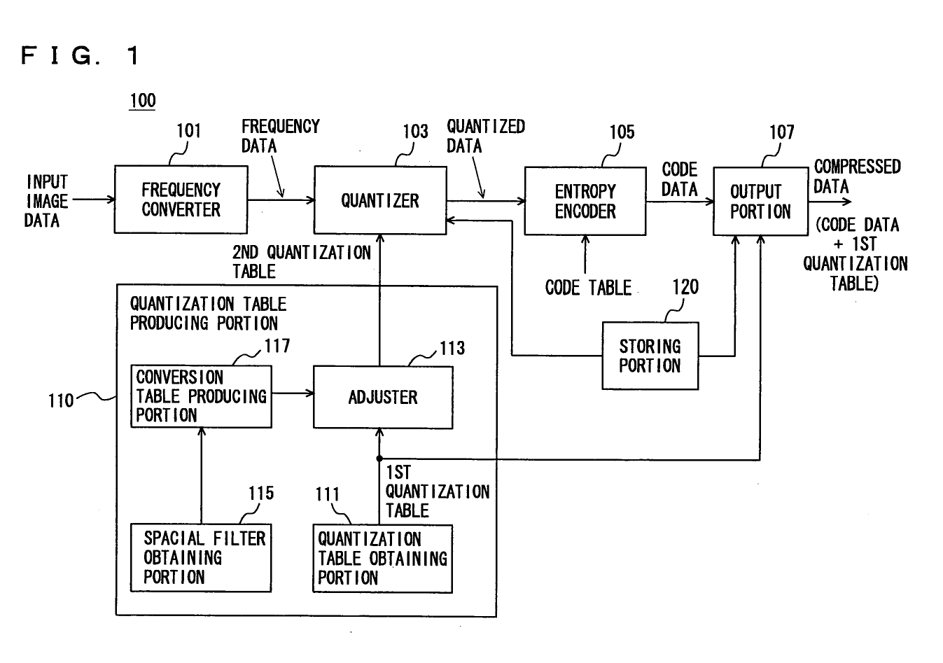

FIG. 1 is a functional block diagram illustrating a schematic structure of an image compression device according to a first embodiment of the invention. Referring to FIG. 1, an image compression device 100 includes a frequency converter 101 for performing frequency conversion on input image data, a quantizer 103 quantizing the frequency-converted data, an entropy encoder 105 for performing entropy encoding on the quantized data, an output portion 107 for outputting the encoded data and a quantization table producing portion 110 for producing a quantization table.

Frequency converter 101 performs orthogonal transformation such as discrete cosine transform (DCT) on the input image data, and thereby performs frequency conversion. The data subjected to the frequency conversion by frequency converter 101 is output to quantizer 103.

Quantizer 103 is connected to frequency converter 101 and quantization table producing portion 110. Frequency converter 101 provides the frequency-converted data, and quantization table producing portion 110 provides the quantization table to be used for the quantization. Quantizer 103 quantizes the frequency-converted data, using the quantization table.

Quantizer 103 receives a second quantization table from quantization table producing portion 110.

Entropy encoder 105 is connected to quantizer 103. Entropy encoder 105 is externally supplied with a code table. Entropy encoder 105 performs entropy encoding on the data quantized by quantizer 103, using the received code table. This code table depends on the input image data, encoding rate and the like, and may be the same as a conventional code table used for JPEG. Entropy encoder 105 provides code data to output portion 107.

For providing the input image data to frequency converter 101, the input image data is practically divided into a plurality of blocks each having an N by N (N×N) matrix of pixels, and the blocks are provided on a block-by-block basis. In this embodiment, each block has the size of an 8 by 8 matrix of pixels, i.e., 64 pixels. Similarly, each of quantizer 103 and entropy encoder 105 is supplied with data on a block-by-block basis.

Quantization table producing portion 110 includes a spatial filter obtaining portion 115 for obtaining a spatial filter, a conversion table producing portion 117 for performing orthogonal transformation on the spatial filter and thereby converting it to data of frequency space, a quantization table obtaining portion 111 for obtaining a first quantization table, and an adjuster 113 producing a second quantization table by adjusting the first quantization table, using a conversion table.

Spatial filter obtaining portion 115 obtains a spatial filter selected from predetermined spatial filters. This selection may be performed by the user, or may be determined in advance. Further, the selection may be performed based on the input image data. The spatial filters include a smoothing filter, a sharpening filter or an edge enhancing filter. For example, when the input image data represents, e.g., a photography having smooth gradation changes, the smoothing filter is selected. When it contains many edge regions such as characters, the sharpening filter or edge enhancing filter is selected. In each kind of the spatial filters, a plurality of spatial filters that achieve different levels of spatial filtering processing, respectively, may be stored in advance for selection. Further, the spatial filter may be selected for each of regions of the input image data. The spatial filter has a size of an M- by M-pixel matrix. For the sake of illustration, it is assumed that the spatial filter has a size of a 3- by 3-pixel matrix.

Conversion table producing portion 117 is connected to spatial filter obtaining portion 115, and is supplied with the spatial filter obtained by spatial filter obtaining portion 115. Conversion table producing portion 117 performs orthogonal transformation such as discrete cosine transform (DCT) on the input spatial filter, and thereby produces the conversion table. The size of the conversion table is equal to the block size (N×N) provided to frequency converter 10. The conversion table has the size of an 8- by 8-pixel matrix.

Description will now be given on a specific method of producing a conversion table of (8×8) in size, using the spatial filter of (3×3) in size.

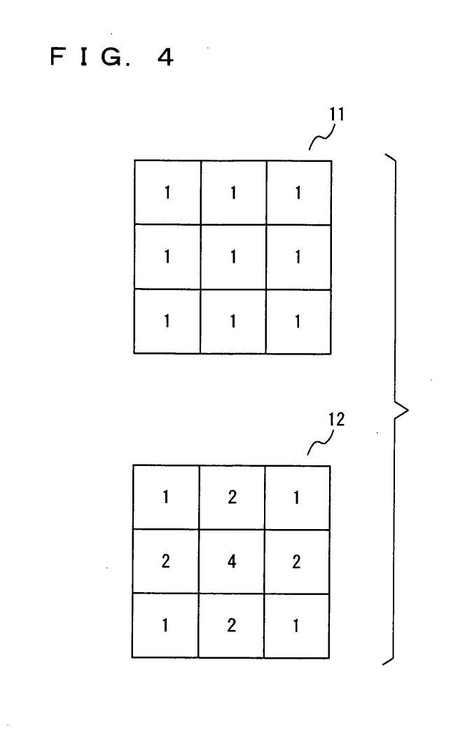

Values of respective elements in the spatial filter (3×3) illustrated in FIG. 4 are predicated that these values are symmetrical (even-symmetrical) with respect to each of longitudinal and lateral axes passing through an origin located at the central element position.

Assuming that f(x, y) represents the spatial filter (3×3), and the central element position of the spatial filter is the origin, the discrete Fourier transform (DFT) provides the frequency response expressed by the following equation (1):

$$F ( {ⅇ}^{j {w}_{1}} , {ⅇ}^{j {w}_{2}} ) = {\sum }_{{k}_{1} = - 1}^{1} {\sum }_{{k}_{2} = - 1}^{1} f ( {k}_{1} , {k}_{2} ) {ⅇ}^{- j {w}_{1} {k}_{1}} {ⅇ}^{- j {w}_{2} {k}_{2}} \qquad ( 1 )$$

Then, it is assumed that the conversion table to be obtained has an (8×8) matrix |F2(i, j)|. The absolute value of F2(i, j) is used because the quantization table for the JPEG cannot represent negative values.

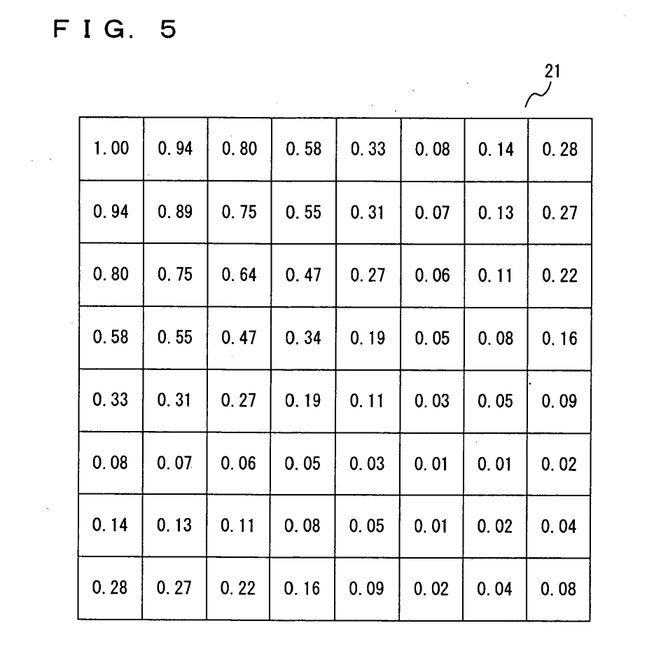

The values of real number part of F(x, y) that is calculated by substituting 0 into each of ω1 and ω2 correspond to matrix |F2(0, 0)| (corresponding to upper left value (1.00) in FIG. 5). The spatial filter f(x, y) is formed of even-symmetrical values, and can be deemed as an even function so that all the imaginary number components are zero, and can be ignored.

Likewise, it is assumed that |F2(0, 1)|, |F2(0, 2)|, . . . and |F2(0, 7)| represent the real number components of F(x, y) that are calculated by changing ω2 to π/8, 2π/8, . . . and π/8, respectively, while keeping ω1 in the equation (1) at 0. For example, 51 F2(0, 7)| corresponds to the lower left value of (0.28).

When ω2 in the equation (1) successively attains 0, π8, 2π/8, and 7π/8, and ω1 in the equation (1) is successively changed to 0, π/8, 2π/8, and 7π/8, respectively, it is assumed that the values of real number components of F(x, y) are equal to the corresponding values of |F2(i, j)|. For example, |F2(7, 7)| takes the value that is calculated by substituting 7π/8 into the (ω1 and ω2 in the equation (1), and corresponds to the lower right value (0.08) in FIG. 5. From the above calculation, the conversion table (see FIG. 5) of (8×8) in size is calculated and produced.

Conversion table producing portion 117 provides the produced conversion table to adjuster 113. Quantization table obtaining portion 111 obtains the predetermined quantization table. A plurality of quantization tables may be predetermined in accordance with the compression levels. In this case, the first quantization table is selected from among the plurality of quantization tables based on the compression level that is externally input. The first quantization table may be selected based on the kind of the input image data. Further, the first quantization table may be prepared by multiplying the predetermined quantization table by a constant p that depends on the compression level.

The size of the quantization table is equal to the block size (N×N) provided to frequency converter 101. This is because quantizer 103 performs the quantization on a block-by-block basis. The first quantization table obtained by quantization table obtaining portion 111 is provided to adjuster 113 and output portion 107.

Adjuster 113 is connected to conversion table producing portion 117 and quantization table obtaining portion 111. It receives the conversion table from conversion table producing portion 117, and also receives the first quantization table from quantization table obtaining portion 111. Adjuster 113 adjusts the table values in the first quantization table by applying the conversion table to it, and thereby produces the second quantization table. Adjuster 113 outputs the second quantization table to quantizer 103.

The respective elements in the second quantization table adjusted by adjuster 113 are equal to the values obtained by dividing the corresponding element values in the first quantization table by the element values in the conversion table, respectively. Thus, adjuster 113 performs the calculation of (Q2(i, j)=Q1(i, j)/F(i, j)), where Q1(i, j), Q2(i, j) and F(i, j) represent the first quantization table, second quantization table and conversion table, respectively. It is preferable that the all elements Q2 (i, j) in the second quantization table are integers, and these integers are obtained by discarding all digits to the right of the decimal point, rounding off to the nearest integer or rounding up to the integer. Theoretically, it is preferable to obtain the integers by rounding off to the integer.

Output portion 107 is connected to entropy encoder 105 and quantization table obtaining portion 111. Output portion 107 receives the encoded data from entropy encoder 105, and also receives the first quantization table from quantization table obtaining portion 111. Output portion 107 outputs the encoded data and the first quantization table in a correlated fashion. The correlated fashion includes a case where the quantization table and the encoded data are integrated as one item of compressed data for output. Since output portion 107 receives the encoded data block by block, individual blocks may be correlated with the quantization table on a block-by-block basis. Also, groups each including the multiple blocks may be correlated with the quantization table on a group-by-group basis.

Image compression device 100 illustrated in FIG. 1 can be achieved by a general computer or a general microprocessor. Frequency converter 101, quantizer 103 and entropy encoder 105 may be formed of LSI elements or the like that are widely used and are dedicated to the JPEG compression processing. Quantization table producing portion 110 and output portion 107 may be achieved, e.g., by a microprocessor or the like.

When quantization table producing portion 110 or image compression device 100 is formed of a personal computer or a microcomputer, programs may be employed for causing the computer to execute the quantization table obtaining processing or image compression processing to be described later. These programs are recorded on record mediums such as CD-ROMs (Compact Disk-Read Only Memories), and are distributed as program products. These programs are read by a CD-ROM drive or the like into a RAM or the like in a computer, and are executed by a Central Processing Unit (CPU). Instead of the CD-ROM, the programs may be recorded on record mediums fixedly bearing the programs such as a flexible disk, cassette tape, hard disk, optical disk (MO (Magneto Optical Disc), MD (Mini Disk) or DVD (Digital Versatile Disk), IC card (including a memory card), optical card, mask ROM, EPROM, EEPROM, flash ROM and other semiconductor memories. Further, the programs may be downloaded from another device over a network such as the Internet.

These programs include programs that can be directly executed by the CPU as well as programs in a source program form, compressed program, encrypted programs and others.

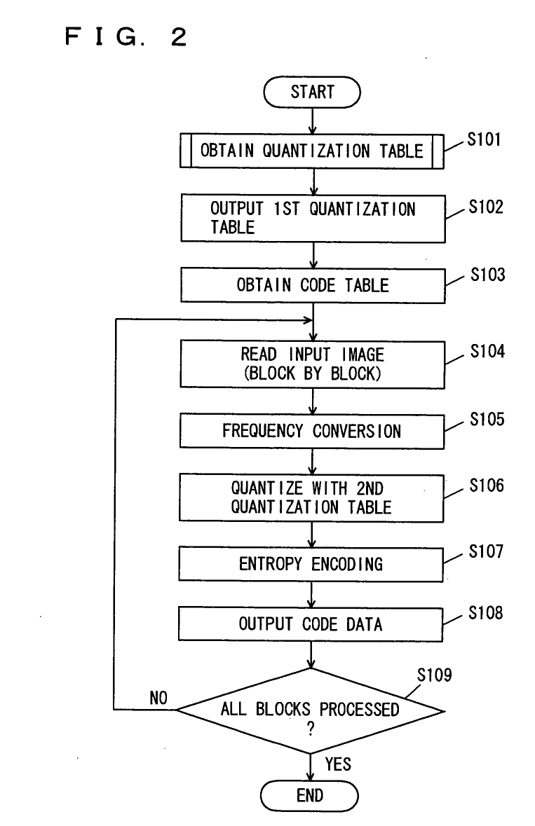

FIG. 2 is a flowchart illustrating flow of the image compression processing executed by the image compression device of the first embodiment. Referring to FIG. 2, the quantization tables are obtained (step S101). The obtained quantization tables are the first and second quantization tables. The quantization table obtaining processing executed in step S101 will be described later.

The obtained first quantization table is provided to a storage device such as a semiconductor memory or a magnetic memory for temporary storage (step S102).

Then, the code table is obtained (step S103). The code table is, e.g., a Huffman code table representing a Huffman code that is a statistical data compression technique.

Then, the input image data is read block by block (step S104). The input image data is, e.g., a color image formed of three planes of a luminance component Y and chrominance components Cb and Cr. It may be a monochrome image formed of only a luminance component Y.

Then, frequency conversion is performed on the input image data that is input on the block-by-block basis in step S104 (step S105). The frequency conversion is, e.g., discrete cosine transform (DCT).

The frequency image subjected to the frequency conversion is quantized using the second quantization table obtained in step S101 (step S106).

Using the code table read in step S103, entropy encoding is performed on the data that is quantized in step S106 (step S107). The encoded data is provided to the storage device to which the first quantization table is provided in step S102, and is stored therein (S108). Thereby, the first quantization table and the code data are output in the correlated fashion.

In step S109, it is determined whether the processing from step S104 to step S108 is completed for all the blocks or not. When it is completed, the processing ends. Otherwise, the process returns to step S104. The first quantization table and the code data are provided as compressed data to another device. The device receiving the compressed data can dequantize it, using the first quantization table.

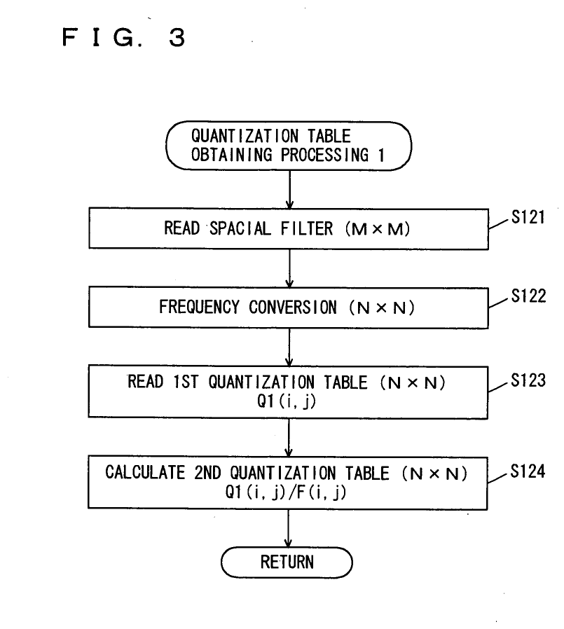

FIG. 3 is a flowchart illustrating flow of quantization table obtaining processing executed by the image compression device of the first embodiment. The quantization table obtaining processing is executed in step S101 of the flowchart illustrated in FIG. 2.

Referring to FIG. 3, the spatial filter is read in step S121. This spatial filter is a filter for image processing, which is prepared by a system designer or the like and is stored in advance. It is now assumed that the spatial filter has a filter size of M×M (M=3).

Then, frequency conversion is performed on the spatial filter (M×M) read in step S121 to produce the conversion table (step S122). The size (N×N) of the conversion table is equivalent to N defining the size (N×N) of the quantization table. It is preferable that the foregoing constant M is the smallest in a range satisfying (3≦M≦2·N−1).

Then, the first quantization table is read (step S123). The first quantization table defines the quantization step in the quantization processing, and is prepared and stored in advance by a system designed or the like. The first quantization table has the size of (N×N). For example, N is equal to 8 in the quantization table (N×N) used in the JPEG compression processing. The quantization table can be freely designed based on certain knowledge or information. However, the quantization table used as a default in the JPEG scheme can be used.

Then, the first quantization table (N×N) read in step S123 is adjusted using the conversion table (N×N) produced in step S122, and thereby the second quantization table is produced (S124). For the sake of illustration, the respective elements in the first quantization table are represented by array Q1(i, j), and the respective elements in the conversion table are represented by array F(i, j). The respective elements Q2(i, j) in the second quantization table are calculated by Q1(i, j)/F(i, j). Variables i and j represent the element positions in the longitudinal direction (row direction) and the lateral direction (column direction), respectively, and the relationships of (1≦i≦N, 1≦j≦N) are satisfied when each of variables i and j starts from “1”, where i and j are integers.

FIG. 4 illustrates an example of the spatial filter. A spatial filter 11 is an example of an eight-neighborhood averaging filter. Spatial filter 11 is employed for performing smoothing on the image data. All elements of spatial filter 11 are equivalently “1”.

The spatial filter is used when convolution is conducted on pixel values of an original image (e.g., a color image formed of RGB, i.e., three planes). In the processing of the convolution, values of respective elements in spatial filter 11 are used as weights, but naturally the normalization must be performed with the sum total of the weights.

A spatial filter 12 is an example of a smoothing filter performing weighted averaging. The eight-neighborhood averaging and weighted averaged described above are examples of element values of the smoothing filter. The structure of the element values of the spatial filter are not restricted to the above. The spatial filter is not restricted to the smoothing filter, and may be a filter such as a sharpening filter achieving another effect.

FIG. 5 illustrates an example of the conversion table that is produced by frequency conversion of spatial filter 11 (M=3) illustrated in FIG. 4. The conversion table has the same size as the quantization table and the block, and thus has the size of (8×8).

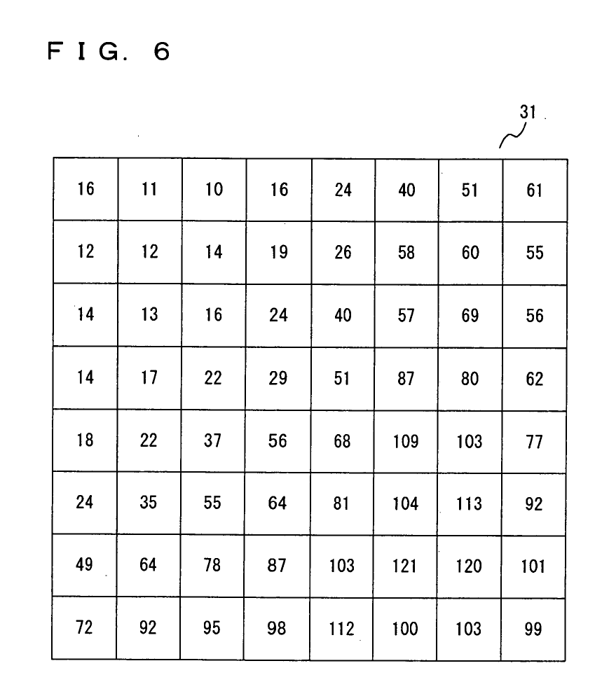

FIG. 6 illustrates a luminance component table in the default quantization table of the JPEG scheme. Referring to FIG. 6, a DC component in a quantization table 31 is represented by the upper left value of “16”, the elements other than the DC component represent the AC components. The frequency component lowers as the position moves to the upper left side, and rises as the position moves to the lower right side. The default quantization table in this embodiment is the first quantization table.

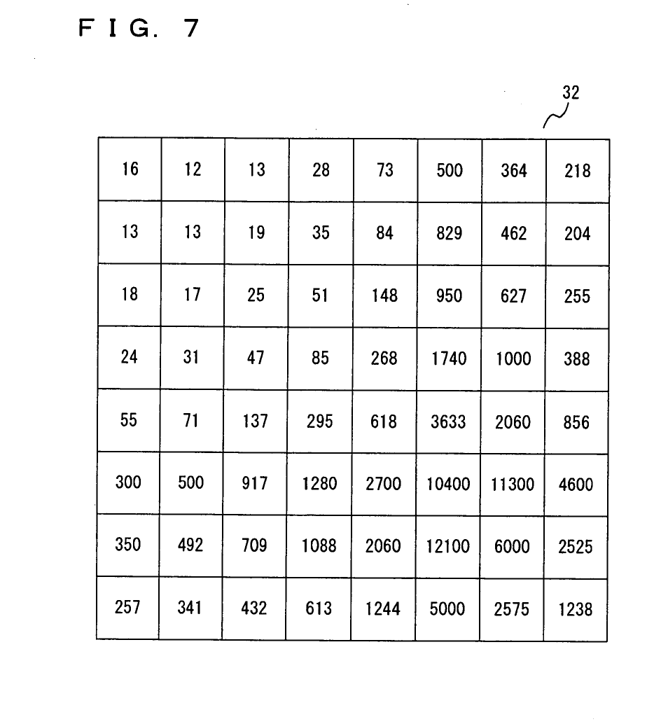

FIG. 7 illustrates an example of the second quantization table calculated from the first quantization table and the conversion table. FIG. 7 illustrates a second quantization table 32 that is obtained by dividing the respective element values in first quantization table 31 illustrated in FIG. 6 by the corresponding element values in a conversion table 21 illustrated in FIG. 5. As illustrated in FIG. 7, it is preferable that every element in second quantization table 32 is an integer, and the integer is obtained from the result of division, e.g., by discarding all digits to the right of the decimal point, rounding off to the nearest integer or rounding up to the integer. Theoretically, it is preferable to obtain the integers by rounding off to the integer. Second quantization table 32 illustrated in FIG. 7 contains element values such as “268” and “1238” equal to or larger than “256”. When pixels in an uncompressed original image take values in a range from 0 to 255, processing may be conducted on the elements of second quantization table 32, e.g., to replace the element values equal or larger than “255” with the values of “255”, respectively.

In the embodiment, it is preferable that the following relationships are present between the conversion table, quantization table and spatial filter.

(1) The conversion table has the elements equal in number to those of the quantization table.

(2) The spatial filter has the elements smaller in number than the elements of the quantization table.

(3) The spatial filter has the elements of which number in the longitudinal direction is equal to that in the lateral direction.

(4) The numbers of the elements in the longitudinal and lateral directions in the conversion table are equal to those in the quantization table, respectively.

In image compression device 100 of the embodiment, quantization table producing portion 110 obtains the first quantization table, and provides it as a quantization table to be used for the dequantization to output portion 107. Also, it produces the second quantization table to be used for the quantization by adjusting the first quantization table, using the spatial filter, and provides it to quantizer 103. Therefore, the second quantization table for use in the quantization in compression processing and the first quantization table for use in the dequantization in decompression processing can be produced readily.

Adjuster 113 produces the second quantization table used for the quantization by adjusting the quantization table to be used for dequantization, using the spatial filter. Therefore, by determining the value of the number (nine) of the elements in the spatial filter, it is possible to determine the quantization table for the quantization as well as the quantization table for the dequantization.

When the smoothing filter is used as the spatial filter, it is possible to reduce noises (e.g., mosquito noises) that are caused by a quantization error occurring in the quantization processing by quantizer 103.

Since quantization table producing portion 110 produces the quantization table to be used for the quantization by performing the adjustment using the spatial filter, the image prepared by decompressing the compressed data is substantially the same as an image that is subjected to image processing using the spatial filter. The spatial filtering processing is not required during the compression and decompression processing.

Further, conversion table producing portion 117 produces the conversion table by performing the frequency conversion on the spatial filter, and adjuster 113 divides the elements in the quantization table by the corresponding elements in the conversion table so that the second quantization table can be readily obtained.

Image compression device 100 further includes a quantization table storing portion 120. Quantization table storing portion 120 stores the foregoing first quantization table and the foregoing second quantization table produced in advance by quantization table producing portion 110 in the correlated fashion.

The processing in this embodiment can also be executed using the first and second quantization tables stored in quantization table storing portion 120.

In this case, frequency converter 101 first performs the frequency conversion on the input image data. Then, quantizer 103 quantizes the data subjected to the frequency conversion by frequency converter 101, using the second quantization table stored in quantization table storing portion 120. Then, entropy encoder 105 performs entropy encoding on the quantized data produced by quantizer 103. Then, output portion 107 outputs the data encoded by entropy encoder 105 and the first quantization table stored in quantization table storing portion 120 in the correlated fashion.

### Second Embodiment

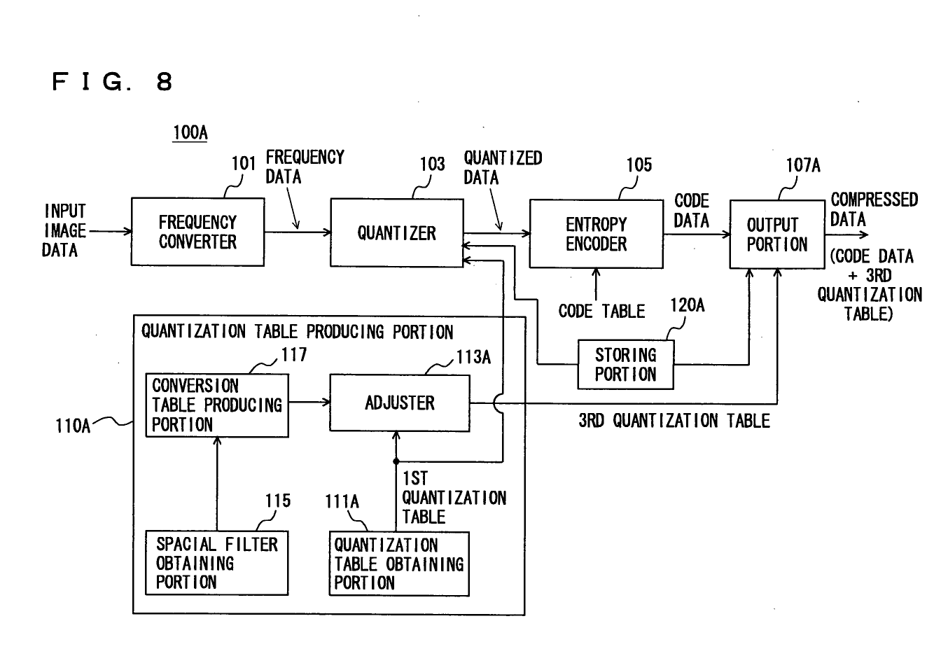

FIG. 8 is a functional block diagram illustrating a schematic structure of an image compression device according to a second embodiment. Referring to FIG. 8, an image compression device 100A of the second embodiment differs from image compression device 100 of the first embodiment in a quantization table obtaining portion 111A, an adjuster 113A, an output portion 107A and a quantization table storing portion 120A. Description will now be given primarily on the differences.

Quantization table obtaining portion 111A obtains a predetermined quantization table. This is the same as the operation of quantization table obtaining portion 111. Quantization table obtaining portion 111A provides the obtained first quantization table to adjuster 113A and quantizer 103. Therefore, quantizer 103 receiving the first quantization table performs the quantization, using the first quantization table.

Adjuster 113A is connected to conversion table producing portion 117 and quantization table obtaining portion 111A. Conversion table producing portion 117 provides the conversion table, and quantization table obtaining portion 111A provides the first quantization table. Adjuster 113A applies the conversion table to the first quantization table to adjust the table values, and thereby produces a third quantization table. In contrast to the fact adjuster 113 produces the second quantization table, adjuster 113A produces the third quantization table. Adjuster 113A provides the produced third quantization table to output portion 107A. The third quantization table is used when dequantizing the frequency image data that is entropy-encoded in the process of decompressing the compressed data.

Adjuster 113A determines the respective elements in the third quantization table to be equal to values obtained by multiplying the corresponding element values in the first quantization table by the element values in the conversion table, respectively. Thus, assuming that Q3(i, j) represents the array of the elements in the third quantization table, adjuster 113A calculates Q3(i, j)=Q1(i, j)·F(i, j). It is preferable that all elements Q3(i, j) in the third quantization table are integers, and each result of multiplication is changed into the integer, e.g., by discarding all digits to the right of the decimal point, rounding off to the nearest integer or rounding up to the integer. Theoretically, it is preferable to obtain the integers by rounding off to the integer.

Output portion 107A is connected to entropy encoder 105 and adjuster 113A. Entropy encoder 105 provides the encoded data to output portion 107A, and adjuster 113A provides the third quantization table to it. Output portion 107A outputs the encoded data and the third quantization table in the correlated fashion. The correlated fashion includes a case where the quantization table and the encoded data are integrated as one item of compressed data for output. Since output portion 107A receives the encoded data block by block, individual blocks may be correlated with the third quantization table on a block-by-block basis. Also, groups each including the multiple blocks may be correlated with the third quantization table on a group-by-group basis.

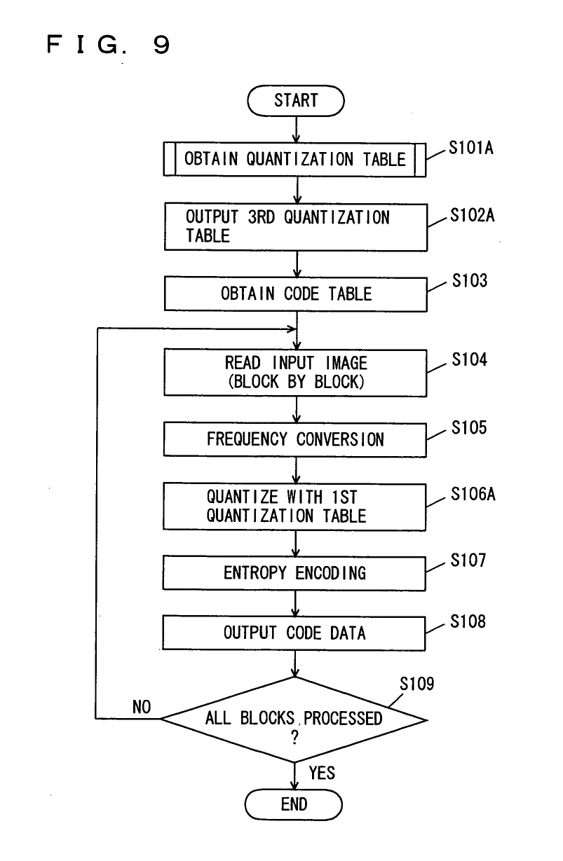

FIG. 9 is a flowchart illustrating flow of the image compression processing executed by the image compression device of the second embodiment. Referring to FIG. 9, the processing differs from the image compression processing executed by image compression device 100 of the first embodiment in steps S101A, S102A and S106A are executed. Description will now be primarily given on the differences in processing.

In step S101A, the quantization tables are obtained. The quantization tables thus obtained are the first and third quantization tables. The processing of obtaining the quantization tables in step S101A will be described later.

In step S102A, the third quantization table obtained in step S101A is provided to a storage device such as a semiconductor memory or a magnetic memory, and is temporarily stored.

In step S106A, the frequency image subjected to frequency conversion is quantized using the first quantization table obtained in step S101A.

In step S108, the encoded data is provided to the storage device to which the third quantization table is also provided in step S102A, and is stored therein. Thereby, the third quantization table and the code data are output in the correlated fashion. The third quantization table and the code data are provided as the compressed data to another device. The device receiving the compressed data thus prepared can dequantize it, using the third quantization table.

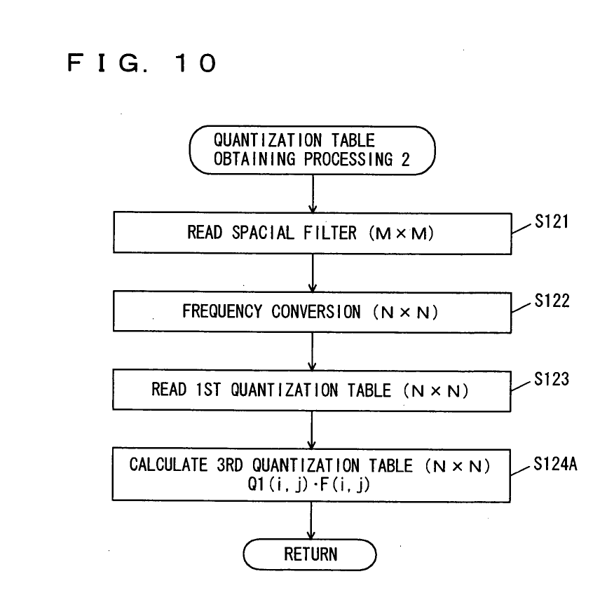

FIG. 10 is a flowchart illustrating flow of the quantization table obtaining processing executed by the image compression device of the second embodiment. This quantization table obtaining processing is executed in step S101A in the flowchart of FIG. 9. Referring to FIG. 10, this processing differs from the quantization table obtaining processing executed by image compression device 100 of the first embodiment illustrated in FIG. 3, and particularly differs therefrom in processing of calculating the third quantization table in step S124A.

In step S124A, the first quantization table (N×N) read in step S123 is adjusted using the conversion table (N×N) produced in step S122, and thereby the third quantization table is produced. Third quantization table Q3(i, j) is calculated by Q1(i, j)·F(i, j).

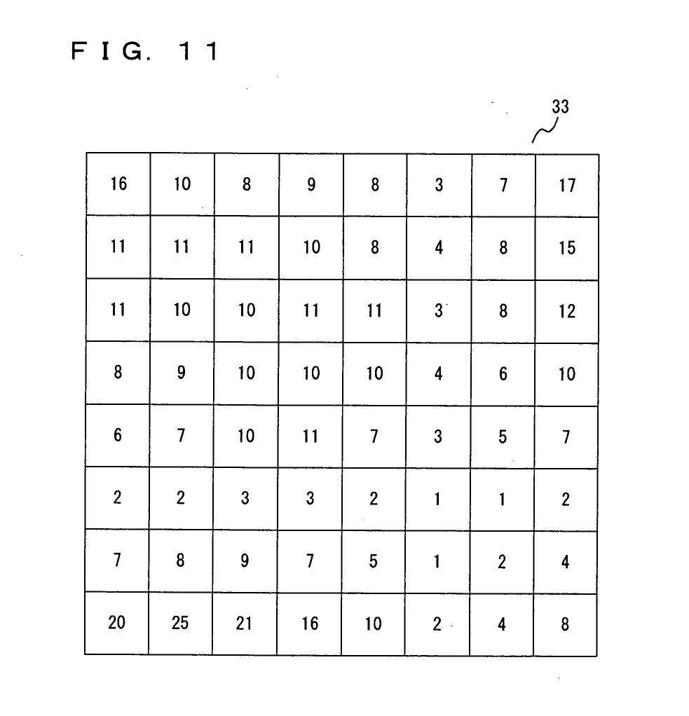

FIG. 11 illustrates an example of the third quantization table calculated from the first quantization table and the conversion table. FIG. 11 illustrates a third quantization table 33 obtaining by multiplying the respective element values in first quantization table illustrated in FIG. 6 by the corresponding element values in conversion table 21 illustrated in FIG. 5. As illustrated in FIG. 11, it is preferable that all the elements in the third quantization table 33 are integers, and each result of multiplication is changed into the integer, e.g., by discarding all digits to the right of the decimal point, rounding off to the nearest integer or rounding up to the integer. Theoretically, it is preferable to obtain the integers by rounding off to the integer.

In image compression device 100A of the second embodiment, as already described, a quantization table producing portion 110A obtains the first quantization table, and provides it to quantizer 103 as the quantization table to be used for the quantization. It also produces the third quantization table to be used for the dequantization by adjusting the first quantization table with the spatial filter, and thereby provides the third quantization table to output portion 107A. Therefore, by determining the number (nine) of the elements in the spatial filter, it is possible to determine the first quantization table for the quantization and the third quantization table for the dequantization. Quantization table producing portion 110A can readily produce the first quantization table to be used for the quantization in the compression processing and the third quantization table to be used for the dequantization in the decompression processing.

Adjuster 113A produces the third quantization table to be used for the dequantization by adjusting the quantization table to be used for the quantization, using the spatial filter. Therefore, the image prepared by decompressing the compressed data is substantially the same as an image that is subjected to image processing using the spatial filter so that the spatial filtering processing is not required in the course of compression or decompression processing.

In particular, when the smoothing filter is used as the spatial filter, it is possible to reduce noises (e.g., mosquito noises) that are caused by a quantization error occurring in the quantization processing by quantizer 103.

Further, conversion table producing portion 117 produces the conversion table by performing the frequency conversion on the spatial filter, and adjuster 113A multiplies the elements in the first quantization table by the corresponding elements in the conversion table. Therefore, the third quantization table can be readily obtained.

When it is difficult to change the structure of image compression device 100A, the filtering processing can be performed on only the decompression device side.

Quantization table storing portion 120A stores the foregoing first quantization table and the third quantization table produced in advance by the foregoing processing in the correlated fashion.

The processing in this embodiment can be executed even by using the first and third quantization tables stored in quantization table storing portion 120A.

In this case, frequency converter 101 performs the frequency conversion on the input image data. Then, using the first quantization table stored in quantization table storing portion 120A, quantizer 103 quantizes the data subjected to the frequency conversion by frequency converter 101. Then, entropy encoder 105 performs the entropy encoding on the quantized data produced by quantizer 103. Then, output portion 107A outputs the data encoded by entropy encoder 105 and the third quantization table stored in quantization table storing portion 120A in the correlated fashion.

### Third Embodiment

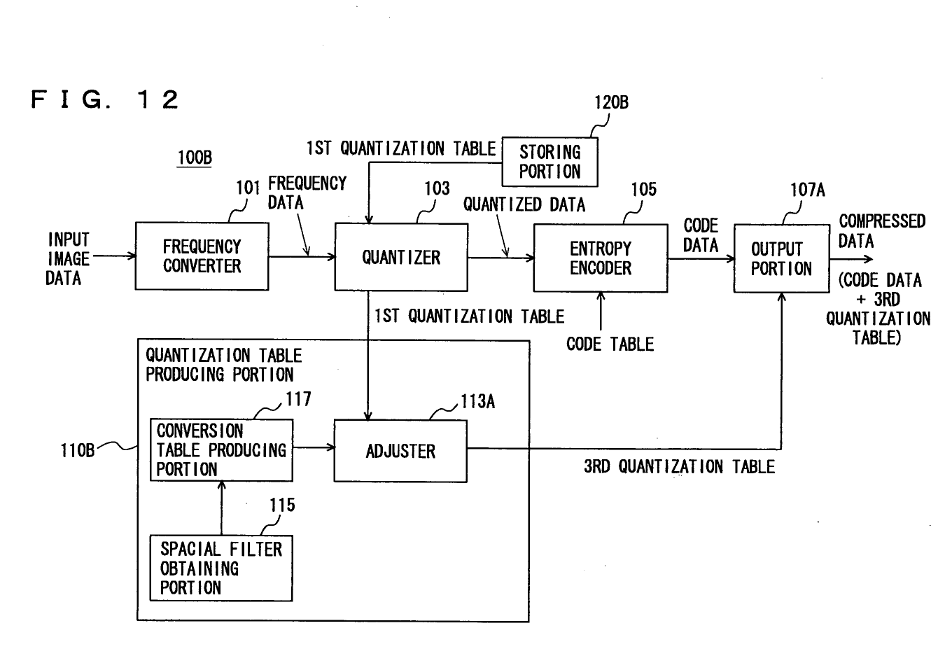

FIG. 12 is a functional block diagram illustrating a schematic structure of an image compression device according to a third embodiment. Referring to FIG. 12, an image compression device 100B according to a third embodiment differs from image compression device 100A of the second embodiment in that image compression device 100B does not include quantization table obtaining portion 111A, and includes a quantization table storing portion 120B instead of quantization table storing portion 120A, and adjuster 113A receives the first quantization table from quantizer 103. Quantization table storing portion 120B has stored in advance the first quantization table. Description will now be given primarily on the differences.

Quantizer 103 receives the first quantization table from quantization table storing portion 120B. Since quantizer 103 receives the first quantization table, it performs the quantization using the first quantization table. Quantizer 103 provides the first quantization table used for the quantization to adjuster 113A.

Adjuster 113A is connected to conversion table producing portion 117 and quantizer 103. It receives the conversion table from conversion table producing portion 117, and receives the first quantization table from quantizer 103. Adjuster 113A adjusts the table values by applying the conversion table to the first quantization table, and thereby produces the third quantization table. Adjuster 113A provides the third quantization table thus produced to output portion 107A. The third quantization table is used for dequantizing the frequency image data subjected to the entropy decoding in the process of decompressing the compressed data.

In image compression device 100B according to the third embodiment, as described above, a quantization table producing portion 110B obtains the first quantization table from the quantizer 103, produces the third quantization table for use in the dequantization by adjusting the first quantization table with the spatial filter, and provides it to output portion 107A. Therefore, even when the quantization table to be used for the quantization in quantizer 103 is different from the quantization table that is actually provided to quantizer 103, it is possible to produce the third quantization table by adjusting the first quantization table used for the quantization. For example, the above is the case where quantizer 103 uses, for quantization, the quantization table produced, e.g., by multiplying the input quantization table by a predetermined factor.

The third embodiment may employ such a manner that conversion table producing portion 117 converts the spatial filter obtained by spatial filter obtaining portion 115 to provide a conversion table, and the conversion table thus prepared is stored in advance. In this case, step S101 A in the image compression processing illustrated in FIG. 9 is executed to read the stored conversion table without executing steps S121 and S122 in the quantization table obtaining processing illustrated in FIG. 10.

### Fourth Embodiment

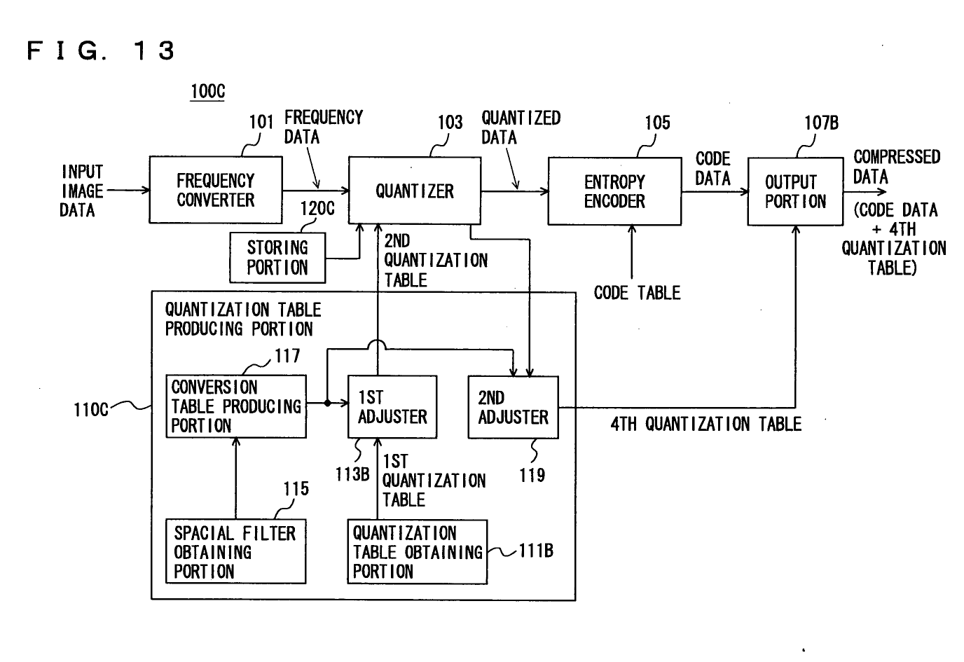

FIG. 13 is a functional block diagram illustrating a schematic structure of an image compression device according to a fourth embodiment. Referring to FIG. 13, an image compression device 100C according to the fourth embodiment differs from image compression device 100 according to the first embodiment in that quantization table obtaining portion 111, adjuster 113, output portion 107 and quantization table storing portion 120 in the first embodiment are replaced with a quantization table obtaining portion 111B, a first adjuster 113B, an output portion 107B and a quantization table storing portion 120C, respectively, and a second adjuster 119 is additionally employed. Description will now be given primarily on the differences.

Quantization table obtaining portion 111 B obtains a predetermined quantization table. This is the same as the operation of quantization table obtaining portion 111. Quantization table obtaining portion 111 B provides the obtained first quantization table only to first adjuster 113B.

First adjuster 113B is connected to conversion table producing portion 117 and quantization table obtaining portion 111B. It receives the conversion table from conversion table producing portion 117, and receives the first quantization table from quantization table obtaining portion 111B. First adjuster 113B adjusts the table values by applying the conversion table to the first quantization table, and thereby produces the second quantization table. This operation is the same as that of adjuster 113. Thus, adjuster 113B provides the second quantization table in which the respective elements are obtained by dividing the corresponding element values in the first quantization table by the element values in the conversion table, respectively. More specifically, first adjuster 113B calculates (Q2(i, j)=Q1(i, j)/F(i, j)) where Q1(i, j) represents the first quantization table, Q2(i, j) represents the second quantization table and F(i, j) represents the conversion table. It is preferable that all elements Q2(i, j) in the second quantization table are integers, and the results of division are changed into integers, e.g., by discarding all digits to the right of the decimal point, rounding off to the nearest integer or rounding up to the integer. Theoretically, it is preferable to obtain the integers by rounding off to the integer.

First adjuster 113B produces the second quantization table to be used for the quantization by quantizer 103, and provides it to quantizer 103. Therefore, quantizer 103 performs the quantization using the second quantization table.

Second adjuster 119 is connected to conversion table producing portion 117 and quantizer 103. It receives the conversion table from conversion table producing portion 117, and receives the second quantization table used for the quantization from quantizer 103. Second adjuster 119 adjusts the table values by applying the conversion table to the second quantization table, and thereby produces a fourth quantization table. The fourth quantization table is used for dequantizing the frequency image data subjected to the entropy decoding in the process of decompressing the compressed data.

Adjustment by second adjuster 119 provides the fourth quantization table in which the respective elements are obtained by multiplying the corresponding element values in the second quantization table by the element values in the conversion table, respectively. More specifically, second adjuster 119 calculates (Q4(i, j)=Q2(i, j)·F(i, j)=(Q1(i, j)/F(i, j))·F(i, j)) where Q4(i, j) represents the array of respective elements in the fourth quantization table. It is preferable that all elements in the fourth quantization table Q4(i, j) are integers, and each result of multiplication is changed into the integer, e.g., by discarding all digits to the right of the decimal point, rounding off to the nearest integer or rounding up to the integer. Theoretically, it is preferable to obtain the integers by rounding off to the integer. Second adjuster 119 produces the fourth quantization table for use in the dequantization, and provides it to output portion 107B.

Output portion 107B is connected to entropy encoder 105 and second adjuster 119. It receives the code data from entropy encoder 105, and receives the fourth quantization table from second adjuster 119. Output portion 107B provides the code data and the fourth quantization table in the correlated fashion. The correlated fashion includes a case where the quantization table and the encoded data are integrated as one item of compressed data for output. Since output portion 107B receives the encoded data block by block, individual blocks may be correlated with the fourth quantization table on a block-by-block basis. Also, groups each including the multiple blocks may be correlated with the fourth quantization table on a group-by-group basis.

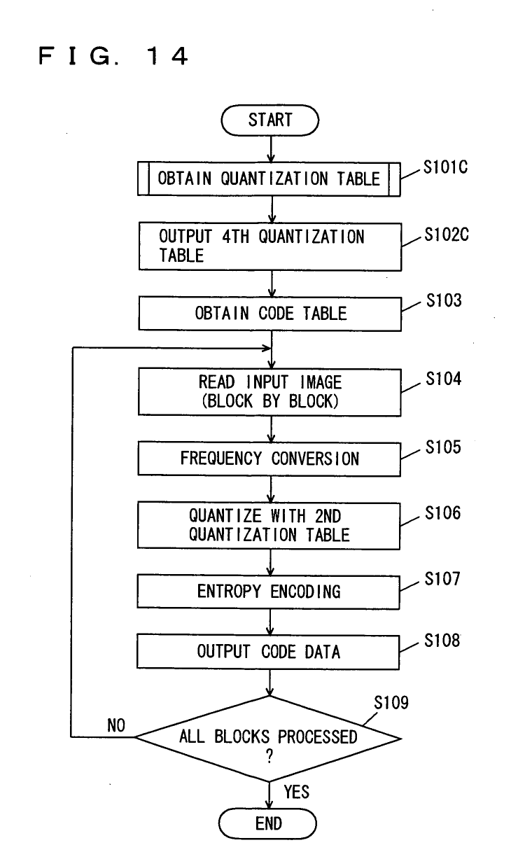

FIG. 14 is a flowchart illustrating flow of the image compression processing executed by the image compression device of the fourth embodiment. Referring to FIG. 14, the processing differs from the image compression processing executed by image compression device 100 of the first embodiment in that steps S101C and S102C are executed. Description will now be primarily given on the differences in processing.

In step S101C, the quantization tables are obtained. The quantization tables thus obtained are the first, second and fourth quantization tables. The processing of obtaining the quantization tables in step S101C will be described later.

In step S102C, the fourth quantization table obtained in step S101C is provided to a storage device such as a semiconductor memory or a magnetic memory, and is temporarily stored.

In step S108, the encoded data is provided to the storage device to which the fourth quantization table is provided in step S102C. Thereby, the fourth quantization table and the code data are output in the correlated fashion. The fourth quantization table and the code data are output as compressed data to another device. A device receiving the compressed data thus prepared can dequantize it, using the fourth quantization table.

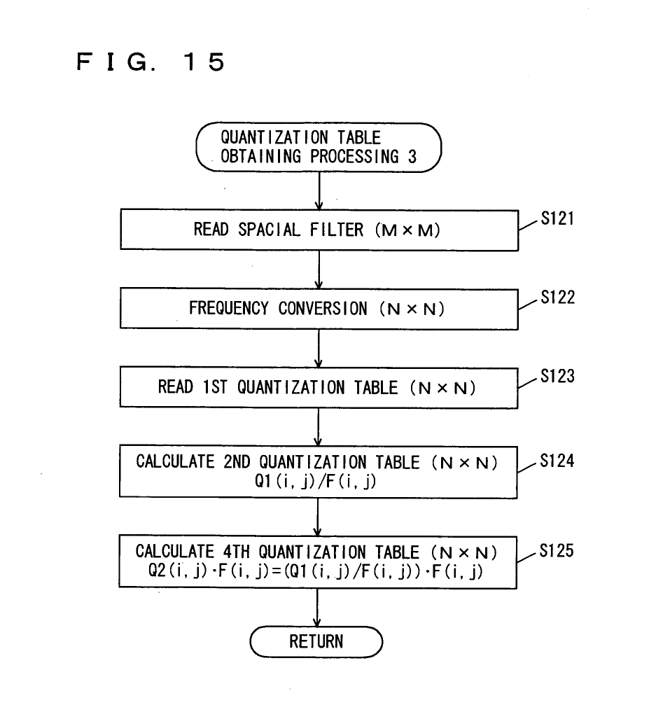

FIG. 15 is a flowchart illustrating flow of the quantization table obtaining processing executed by the image compression device of the fourth embodiment. This quantization table obtaining processing is executed in step S101C in the flowchart of FIG. 14. Referring to FIG. 15, this processing differs in addition of step S125 from the quantization table obtaining processing executed by image compression device 100 of the first embodiment illustrated in FIG. 3.

In step S125, the second quantization table (N×N) calculated in step S124 is adjusted using the conversion table (N×N) produced in step S122, and thereby the fourth quantization table is produced. Elements in fourth quantization table Q4(i, j) is calculated by Q2(i, j)·F(i, j).

In image compression device 100C according to the fourth embodiment, as described above, a quantization table producing portion 110C produces the second quantization table used for the quantization by adjusting the first quantization table, using the special filter, and provides it to quantizer 103. The second quantization table provided from quantizer 103 and used for the quantization is adjusted using the spatial filter to produce the fourth quantization table to be used for the dequantization, and is provided to output portion 107B. Therefore, even when the quantization table to be used for the quantization by quantizer 103 is different from the quantization table that is actually provided to quantizer 103, it is possible to produce the fourth quantization table by adjusting the second quantization table used for the quantization. For example, the above is the case where quantizer 103 uses, for quantization, the quantization table produced, e.g., by multiplying the input quantization table by a predetermined factor.

The fourth embodiment may employ such a manner that conversion table producing portion 117 converts the spatial filter obtained by spatial filter obtaining portion 115 to provide a conversion table, and the conversion table thus prepared is stored in advance. In this case, step S101C in the image compression processing illustrated in FIG. 14 is executed to read the stored conversion table without executing steps S121 and S122 in the quantization table obtaining processing illustrated in FIG. 15, and steps S123-S125 are executed.

Quantization table storing portion 120C has stored the second quantization table that is produced in advance by first adjuster 113B adjusting the first quantization table with the spatial filter.

The processing in this embodiment can be executed also by using the second quantization table stored in quantization table storing portion 120C.

In this case, frequency converter 101 performs the frequency conversion on the input image data. Then, quantizer 103 quantizes the data subjected to the frequency conversion by frequency converter 101, using the second quantization table stored in quantization table storing portion 120C. Second adjuster 119 applies the spatial filter to the second quantization table used for the quantization to adjust the table values, and thereby produces the fourth quantization table to be used for dequantization.

Entropy encoder 105 performs the entropy encoding on the quantized data produced by quantizer 103. Then, output portion 107B outputs the data encoded by entropy encoder 105 and the fourth quantization table in the correlated fashion.

In this case, step S101C in the image compression processing illustrated in FIG. 14 is executed in such a manner that steps S121-S124 in the quantization table obtaining processing illustrated in FIG. 15 are not executed, and step S125 is executed by reading the prestored conversion table and the second quantization table.

### Fifth Embodiment

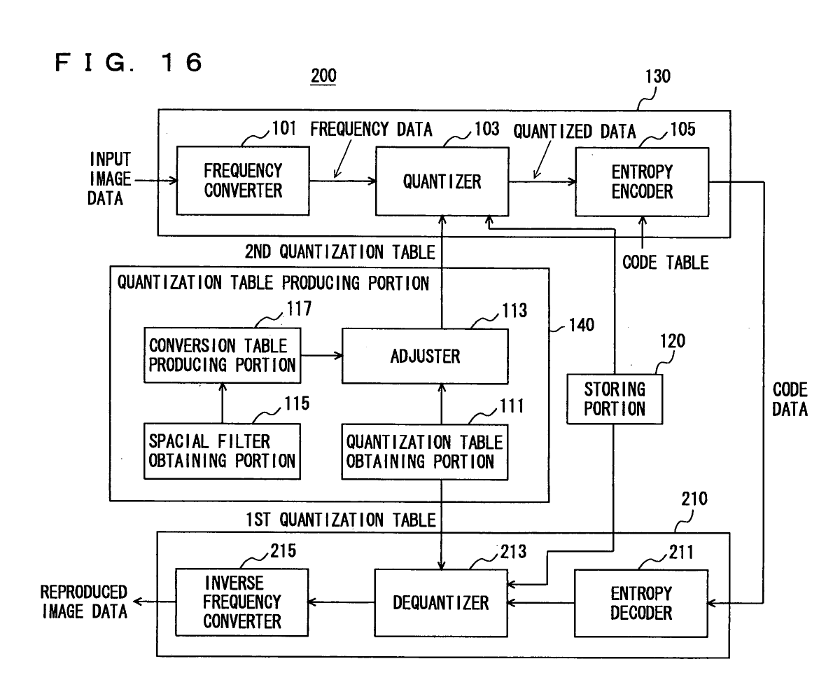

FIG. 16 is a functional block diagram illustrating a schematic structure of an image compression/decompression device according to a fifth embodiment of the invention. Referring to FIG. 16, an image compression/decompression device 200 includes a quantization table producing portion 140, an image compressing portion 130, an image decompressing portion 210 and quantization table storing portion 120.

Image compressing portion 130 includes frequency converter 101 for performing frequency conversion on input image data, quantizer 103 quantizing the frequency-converted data and entropy encoder 105 for performing entropy encoding on the quantized data.

Quantization table producing portion 140 has substantially the same structure as quantization table producing portion 110 in the first embodiment already described except for that the first quantization table obtained by quantization table obtaining portion 111 is provided to a dequantizer 213 instead of output portion 107.

Image decompressing portion 210 includes an entropy decoder 211 for decoding the code data, a dequantizer 213 for dequantizing the decoded data and an inverse frequency converter 215 for performing inverse frequency conversion on the dequantized data.

Entropy decoder 211 is connected to entropy encoder 105, and receives the code data from entropy encoder 105. Entropy decoder 211 decodes the received code data, and provides the decoded data to dequantizer 213.

Dequantizer 213 is connected to entropy decoder 211 and quantization table obtaining portion 111. Dequantizer 213 receives the first quantization table from quantization table obtaining portion 111. Dequantizer 213 dequantizes the data received from entropy decoder 211, using the first quantization table received from quantization table obtaining portion 111. Therefore, dequantizer 213 performs the dequantization using the first quantization table.

Inverse frequency converter 215 is connected to dequantizer 213. Inverse frequency converter 215 converts the received data into the image data by performing orthogonal transformation such as discrete cosine transform.

In image compression/decompression device 200 according to the fifth embodiment, image compressing portion 130 performs the quantization using the second quantization table, and image decompressing portion 210 performs the dequantization using the first quantization table.

Quantization table storing portion 120 stores, in the correlated fashion, the first quantization table and the second quantization table that is produced in advance by the foregoing processing.

The processing in this embodiment may be executed using the first and second quantization tables stored in quantization table storing portion 120.

In this case, image compressing portion 130 performs the quantization using the second quantization table stored in quantization table storing portion 120. Image decompressing portion 210 performs the dequantization using the first quantization table stored in quantization table storing portion 120.

### Sixth Embodiment

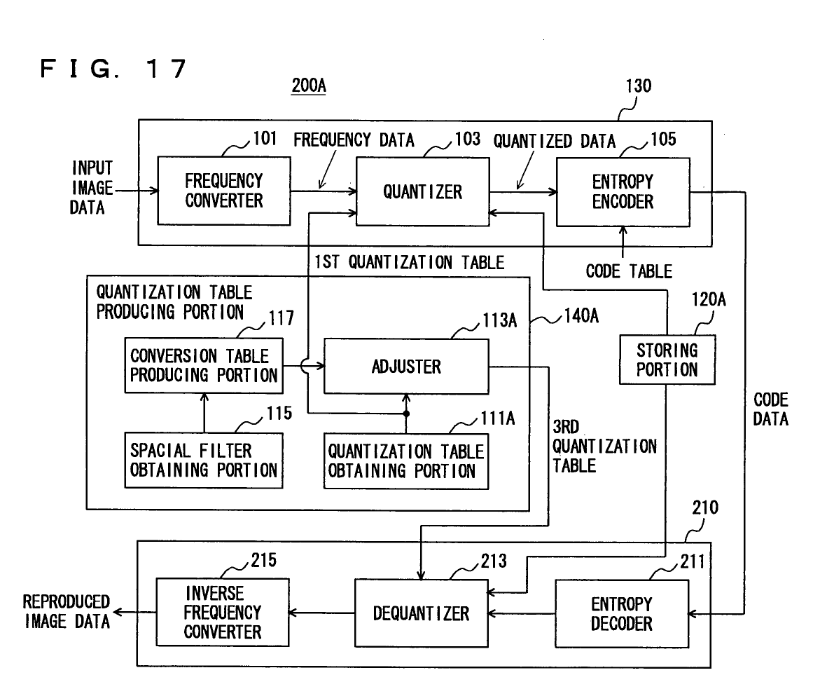

FIG. 17 is a functional block diagram illustrating a schematic structure of an image compression/decompression device according to a sixth embodiment of the invention. Referring to FIG. 17, an image compression/decompression device 200A according to the sixth embodiment is the same as image compression/decompression device 200 according to the fifth embodiment except for that quantization table producing portion 140 is replaced with a quantization table producing portion 140A, and quantization table storing portion 120 is replaced with quantization table storing portion 120A. Quantization table producing portion 140A has substantially the same structure as quantization table producing portion 110A already described in connection with the second embodiment except for that the third quantization table produced by adjuster 113A is provided to dequantizer 213 instead of output portion 107A.

In image compression/decompression device 200A according to the sixth embodiment, image compressing portion 130 performs the quantization using the first quantization table obtained from quantization table producing portion 140A, and image decompressing portion 210 performs the dequantization using the third quantization table obtained from quantization table producing portion 140A.

Quantization table storing portion 120A stores, in the correlated fashion, the first quantization table and the third quantization table that is produced in advance by the foregoing processing.

The processing in this embodiment may be executed using the first and third quantization tables stored in quantization table storing portion 120A.

In this case, image compressing portion 130 performs the quantization using the first quantization table stored in quantization table storing portion 120A. Image decompressing portion 210 performs the dequantization using the third quantization table stored in quantization table storing portion 120A.

### Seventh Embodiment

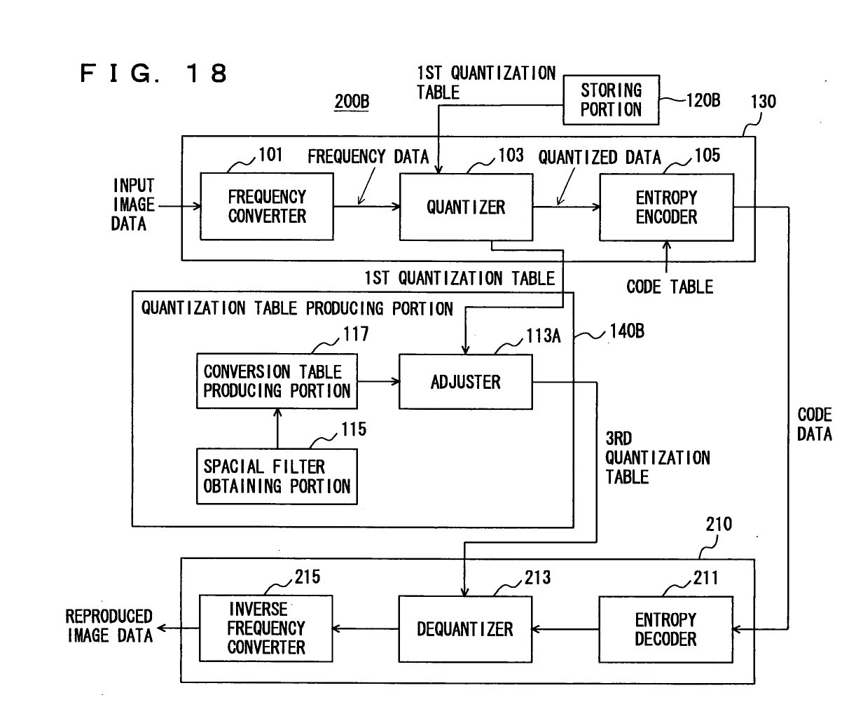

FIG. 18 is a functional block diagram illustrating a schematic structure of an image compression/decompression device according to a seventh embodiment of the invention. Referring to FIG. 18, an image compression/decompression device 200B according to the seventh embodiment is the same as image compression/decompression device 200 according to the fifth embodiment except for that quantization table producing portion 140 is replaced with a quantization table producing portion 140B, and quantization table storing portion 120 is replaced with quantization table storing portion 120B. Quantization table producing portion 140B has substantially the same structure as quantization table producing portion 110B already described in connection with the third embodiment. Quantization table storing portion 120B has stored in advance the first quantization table.

In image compression/decompression device 200B according to the seventh embodiment, image compressing portion 130 performs the quantization using the first quantization table stored in quantization table storing portion 120B, and image decompressing portion 210 performs the dequantization using the third quantization table obtained from quantization table producing portion 140B.

### Eighth Embodiment

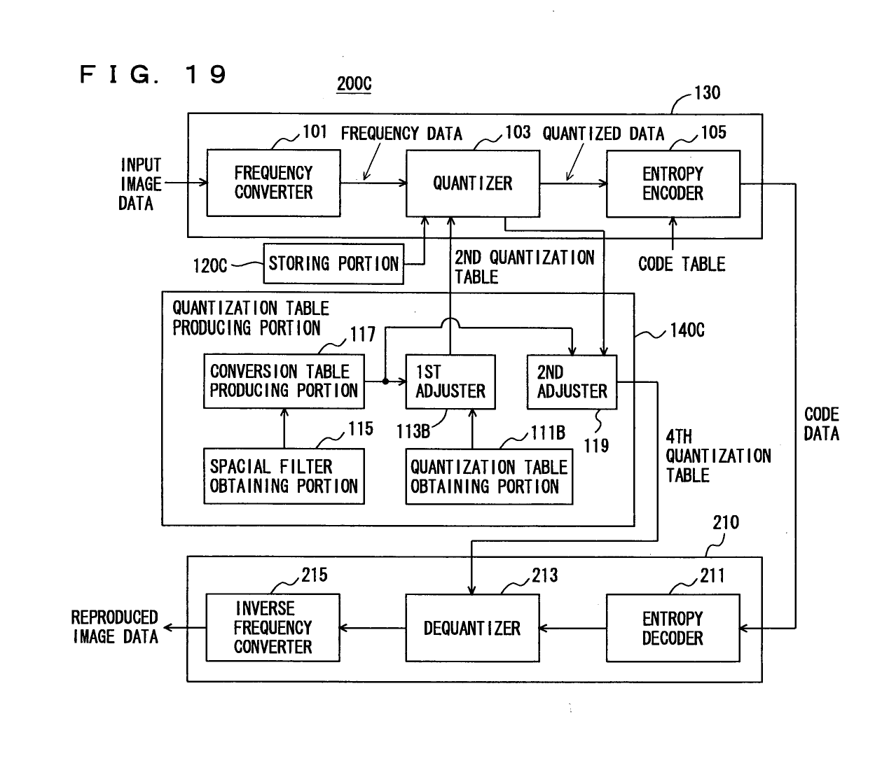

FIG. 19 is a functional block diagram illustrating a schematic structure of an image compression/decompression device according to an eighth embodiment of the invention. Referring to FIG. 19, an image compression/decompression device 200C according to the eighth embodiment is the same as image compression/decompression device 200 according to the fifth embodiment except for that quantization table producing portion 140 is replaced with a quantization table producing portion 140C, and quantization table storing portion 120 is replaced with quantization table storing portion 120C. Quantization table producing portion 140C has substantially the same structure as quantization table producing portion 110C already described in connection with the fourth embodiment except that the fourth quantization table produced by second adjuster 119 is provided to dequantizer 213 instead of output portion 107B.

In image compression/decompression device 200C according to the seventh embodiment, image compressing portion 130 performs the quantization using the second quantization table obtained from quantization table producing portion 140C, and image decompressing portion 210 performs the dequantization using the fourth quantization table obtained from quantization table producing portion 140C.

Quantization table storing portion 120C has stored the second quantization table that was produced in advance.

The processing in this embodiment can also be executed using the second quantization table stored in quantization table storing portion 120C. In this case, image compressing portion 130 performs the quantization using the second quantization table stored in quantization table storing portion 120C. Processing other than the above are the same as the foregoing processing.

### Ninth Embodiment

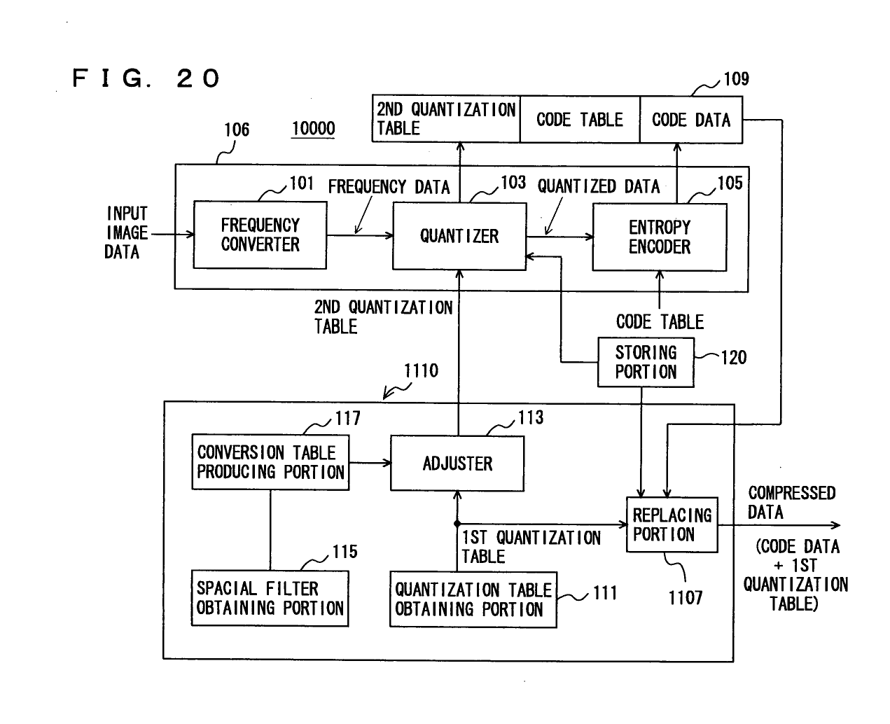

FIG. 20 is a functional block diagram illustrating a schematic structure of an image compression device according to a ninth embodiment of the invention. Referring to FIG. 20, an image compression device 10000 includes a compressing portion 106, a quantization table producing portion 1110, a data buffer 109 and quantization table storing portion 120.

Compressing portion 106 includes frequency converter 101, quantizer 103 and entropy encoder 105, all of which are already described.

Frequency converter 101 performs the frequency conversion on the input image data by performing orthogonal transformation such as discrete cosine transform (DCT). The data subjected to the frequency conversion by frequency converter 101 is provided to quantizer 103.

Quantizer 103 is connected to frequency converter 101 and quantization table producing portion 1110. It receives frequency-converted data from frequency converter 101, and receives the quantization table to be used for the quantization from quantization table producing portion 1110. Quantizer 103 quantizes the frequency-converted data, using the quantization table. Quantizer 103 provides the quantization table used for the quantization to data buffer 109. Thereby, data buffer 109 stores the quantization table used for the quantization by quantizer 103.

Quantizer 103 receives the second quantization table from quantization table producing portion 1110.

Entropy encoder 105 is connected to quantizer 103. Entropy encoder 105 externally receives the foregoing code table. Entropy encoder 105 performs the entropy encoding on the data quantized by quantizer 103, using the received code table.

Entropy encoder 105 provides the code table used for the encoding to data buffer 109. Entropy encoder 105 also provides the code data to data buffer 109. Thereby, data buffer 109 stores the code table used for encoding by entropy encoder 105 and the encoded code data.

Actually, the input image data is provided to frequency converter 101 in such a manner that the input image data is divided into a plurality of blocks each having an N by N matrix of pixels, and these blocks are provided to frequency converter 101 on a block-by-block basis. In this embodiment, each block has the size of an 8 by 8 matrix of pixels, i.e., 64 pixels. Quantizer 103 and entropy encoder 105 likewise receive the data on a block-by-block basis.

Data buffer 109 is a storage device such as a semiconductor memory (e.g., RAM (Random Access Memory)) or the like. It may be a device other than the semiconductor memory, and may be a magnetic storage device, magneto-optical storage device, optical storage device or the like. Data buffer 109 stores the second quantization table used for the quantization by quantizer 103 and the code data encoded by entropy encoder 105. Since these are stored in data buffer 109, the quantization table used for the quantization and the code data are correlated. In this embodiment, data buffer 109 stores the second quantization table.

Quantization table producing portion 1110 includes spatial filter obtaining portion 115 for obtaining the foregoing spatial filter, conversion table producing portion 117 for performing orthogonal transformation on the spatial filter and thereby converting it to data of frequency space, quantization table obtaining portion 111 for obtaining the first quantization table, adjuster 113 producing the second quantization table by adjusting the first quantization table, using the conversion table, and a replacing portion 1107 for replacing the quantization table used of the quantization with the quantization table to be used for the dequantization.

Spatial filter obtaining portion 115 obtains a spatial filter selected from predetermined spatial filters similarly to the processing already described. The function and operation of spatial filter obtaining portion 115 are the same as those already described, and therefore description thereof is not repeated. The spatial filter is substantially the same as that already described, and therefore description thereof is not repeated. For the sake of illustration, it is assumed that the spatial filter has a size of a 3- by 3-pixel matrix.

The function and operation of conversion table producing portion 117 are the same as those already described, and therefore description thereof is not repeated.

The function and operation of quantization table obtaining portion 111 are the same as those already described, and therefore description thereof is not repeated.

The quantization table has the same size (N×N) as the block provided to frequency converter 101. This is because quantizer 103 performs the quantization on a block-by-block basis. The first quantization table obtained by quantization table obtaining portion 111 is provided to adjuster 113 and replacing portion 1107.

The function and operation of adjuster 113 are the same as those already described, and therefore description thereof is not repeated.

Replacing portion 1107 is connected to quantization table obtaining portion 111 and data buffer 109. Replacing portion 1107 receives the quantization table to be used for the dequantization from quantization table obtaining portion 111. Replacing portion 1107 reads the quantization table used for the quantization, code table and code data from data buffer 109, and replaces the quantization table used for the quantization with the quantization table to be used for the dequantization. In this embodiment, replacing portion 1107 replaces the second quantization table stored in data buffer 109 with the first quantization table provided from quantization table obtaining portion 111.

Replacing portion 1107 outputs the first quantization table, code table and code data. More specifically, replacing portion 1107 outputs the first quantization table to be used for the dequantization and the code data in the correlated fashion. The correlated fashion includes a case where the quantization table is added as a header to the code data, and these are output as one item of compressed data. Individual blocks may be correlated with the quantization table on a block-by-block basis. Also, groups each including the multiple blocks may be correlated with the quantization table on a group-by-group basis.

Image compression device 10000 illustrated in FIG. 20 can be achieved by a general computer or a general microprocessor. Compressing portion 106 may be formed of an LSI element or the like that is widely used and is dedicated to the JPEG compression processing. Compressing portion 106, data buffer 109 and quantization table producing portion 1110 may be achieved, e.g., by one LSI element.

Quantization table producing portion 1110 or image compression device 10000 may be formed of a personal computer or a microcomputer, in which case the image compression processing to be described later may be described by programs causing the computer to execute the processing. These programs are distributed as program products in which the programs are recorded on record mediums such as CD-ROMs (Compact Disc-Read Only Memories), and are read by CD-ROM drives into RAMs or the like in the computers for execution by Central Processing Units (CPUs). In addition to the CD-ROM, the foregoing mediums fixedly bearing the programs may be used as the record mediums storing the programs. Further, the programs may be downloaded from another device over the network such as the Internet.

The programs discussed above may include programs that can be directly executed by the CPU as well as programs in a source program form, compressed programs, encrypted programs and the like.

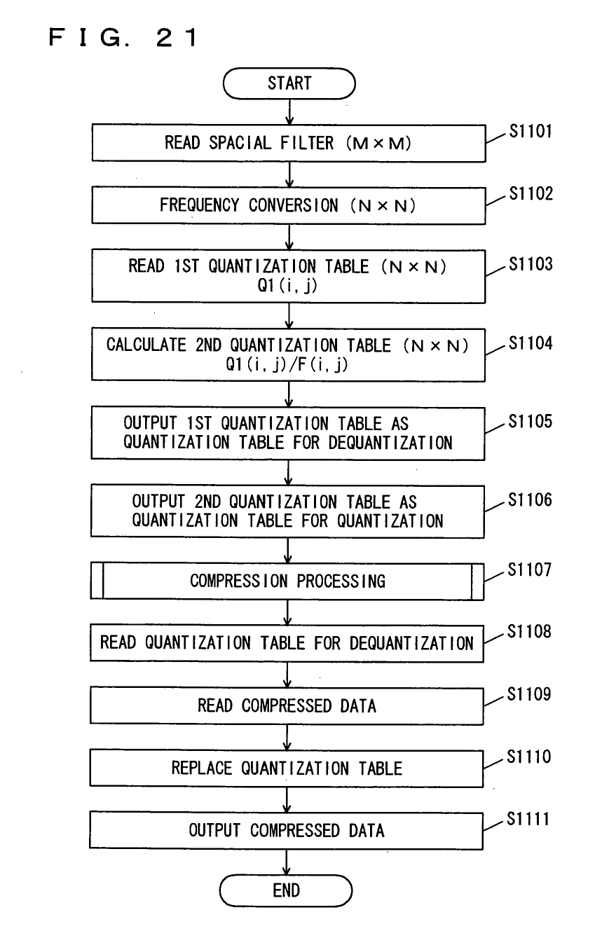

FIG. 21 is a flowchart illustrating flow of the image compression processing executed by the image compression device of the ninth embodiment. Referring to FIG. 21, the spatial filter is read (S1101). This space filter, which is employed for image processing, is prepared by a system designer or the like, and is stored in advance. The spatial filter in this embodiment has a filter size of (M×M, (M=3)) The frequency conversion is performed on the spatial filter (M×M) read in step S1101 to produce the conversion table (step S1102) similarly to the foregoing step S122.

Then, the first quantization table is read (step S1103). The first quantization table is substantially the same as that already described, and therefore description thereof is not repeated.

Then, the first quantization table (N×N) read in step S1103 is adjusted using the conversion table (N×N) produced in step S1102, and thereby the second quantization table is produced (step S1104). For the sake of illustration, the respective elements in the first quantization table are represented by array Q I(i, j), and the respective elements in the conversion table are represented by array F(i, j). The respective elements Q2(i, j) in the second quantization table are calculated by Q1(i, j)/F(i, j). Variables i and j represent the element positions in the longitudinal direction (row direction) and the lateral direction (column direction), respectively, and the relationships of (1≦i≦N, 1≦j≦N) are satisfied when each of variables i and j starts from “1”, where i and j are integers.

In step S1105, the first quantization table read in step S1103 is output as the quantization table for the dequantization. In step S1106, the second quantization table calculated in step S1104 is output as the quantization table for the quantization. The first and second quantization tables are output to the semiconductor memory such as a RAM arranged in image compression device 10000.

In next step S1107, the compression processing is executed. Compressing portion 106 executes this compression processing. Details of the compression processing will be described later. When this compression processing ends, data buffer 109 has stored the second quantization table used for the quantization by quantizer 103 as well as the code table and the code data used for encoding by entropy encoder 105.

In step S1108, the first quantization table for dequantization stored in step S1105 is read. In next step S1109, processing is performed to read the compressed data stored in data buffer 109, i.e., the second quantization table as well as the code table and the code data used for encoding by entropy encoder 105. The second quantization table used for the quantization in the compressed data thus read is replaced with the first quantization table for dequantization read in step S1108 (step S1110). In step S1110, since the quantization table is replaced, the format of the compressed data does not change. In step S1111, the compressed data in which the quantization table is replaced is output.

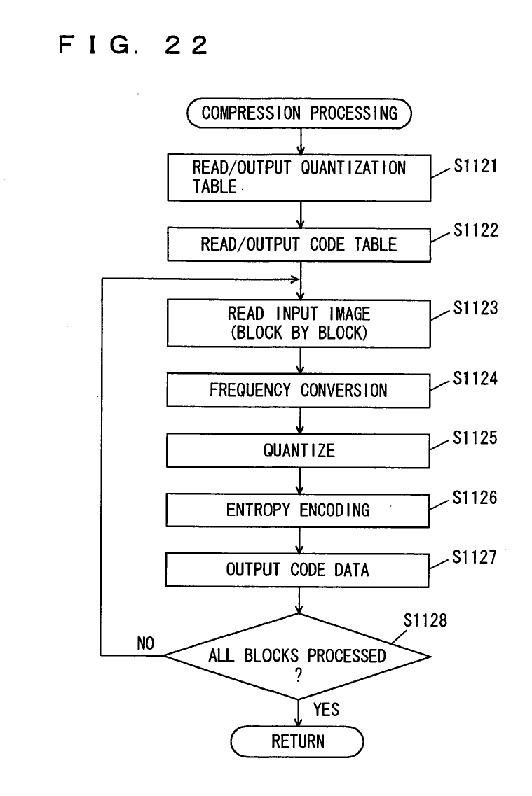

FIG. 22 is a flowchart illustrating flow of the compression processing. This compression processing is executed in step S1107 in FIG. 21. In the compression processor, as illustrated in FIG. 22, the quantization table to be used for the quantization is read and provided to data buffer 109 (step S1121). Data buffer 109 stores the quantization table to be used for the quantization as a part (e.g., header) of the compressed data. The quantization table that is read in this processing is the second quantization table.

Then, the code table is read and provided to data buffer 109 (step S1122). Data buffer 109 stores the code table used for encoding as a part (e.g., header) of the compressed data. The code table that is read in this processing is, e.g., the Huff-man code table representing the Huffman code that is a statistical data compression technique.

Then, the input image data is read on a block-by-block basis (step S1123). Although the block size is 8- by 8-pixel matrix, the block size is not restricted to this, and can be appropriately determined. The input image is, e.g., a color image formed of three planes of a luminance component Y and chrominance components Cb and Cr. It may be a monochrome image formed of only a luminance component Y.

Then, the frequency conversion is performed on the image data provided on the block-by-block basis in step S1123 (step S1124). The frequency conversion is, e.g., discrete cosine transform (DCT).

The frequency image subjected to the frequency conversion is quantized using the quantization table for the quantization that is read in step S1121 (S1125).

The entropy encoding is performed on the data quantized in step S1125, using the code table read in step S1122 (step S1126). The code data that is subjected to the entropy encoding in step S1126 is provided to data buffer 109 (S1127). Data buffer 109 has stored the code data and the second quantization table used for the quantization in the correlated fashion.

In step S1128, it is determined whether the processing in steps S1123-S1127 was performed on all the blocks or not. When the processing was performed, the process ends. Otherwise, the process returns to step S1123.

In image compression device 10000 according to this embodiment, quantization table producing portion 1110 obtains the first quantization table, and provides it as the quantization table to be used for the dequantization to replacing portion 1107. The first quantization table is adjusted using the spatial filter, and thereby the second quantization table to be used for the quantization is produced and provided to quantizer 103. Therefore, the second quantization table to be used for the quantization in the compression processing and the first quantization table to be used for the dequantization in decompression processing can be readily produced.

Adjuster 113 produces the second quantization table to be used for the quantization by adjusting the first quantization table to be used for the dequantization, using the spatial filter. Therefore, by determining the value of the number (9) of elements in the spatial filter, it is possible to determine the quantization table for the quantization and the quantization table for the dequantization. In particular, when the smoothing filter is used as the spatial filter, it is possible to reduce noises (e.g., mosquito noises) that are caused by a quantization error occurring in the quantization processing by quantizer 103.

Since quantization table producing portion 1110 produces the quantization table to be used for the quantization by performing the adjustment using the spatial filter, the image prepared by decompressing the compressed data is substantially the same as an image that is subjected to image processing using the spatial filter. The spatial filtering processing is not required during the compression and decompression processing.

Further, conversion table producing portion 117 produces the conversion table by performing the frequency conversion on the spatial filter, and adjuster 113 divides the elements in the quantization table by the corresponding elements in the conversion table so that the second quantization table can be readily obtained.

Quantization table storing portion 120 stores the foregoing first quantization table and the foregoing second quantization table that is produced in advance by the foregoing processing of quantization table producing portion 1110, and particularly stores these tables in the correlated fashion.

The processing in this embodiment can also be executed using the first and second quantization tables stored in quantization table storing portion 120.

In this case, frequency converter 101 first performs the frequency conversion on the input image data. Then, quantizer 103 quantizes the data subjected to the frequency conversion by frequency converter 101, using the second quantization table stored in quantization table storing portion 120. Quantizer 103 stores the second quantization table in data buffer 109.

Then, entropy encoder 105 performs entropy encoding on the quantized data produced by quantizer 103. Entropy encoder 105 stores the entropy-encoded code data in data buffer 109 in a fashion correlated with the second quantization table.

Then, replacing portion 1107 replaces the second quantization table correlated with the encoded code data by data buffer 109 with the first quantization table stored in quantization table storing portion 120.

Thus, in the image compression processing illustrated in FIG. 21, the stored first quantization table and second quantization table are read without executing the steps S1101-S1104.

### Tenth Embodiment

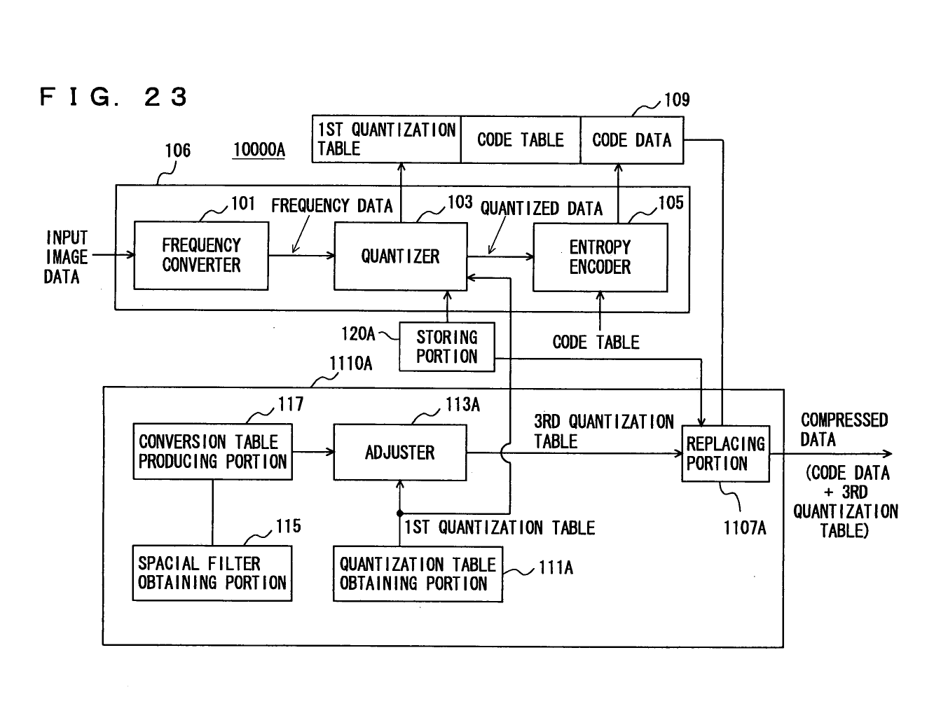

FIG. 23 is a functional block diagram illustrating a schematic structure of an image compression device according to a tenth embodiment of the invention. Referring to FIG. 23, an image compression device 10000A according to the tenth embodiment is the same as image compression device 10000 according to the ninth embodiment except for quantization table obtaining portion 111A, adjuster 113 A and a replacing portion 1107A in a quantization table producing portion 1110A as well as quantization table storing portion 120A. Description will now be primarily given on the differences.

Quantization table obtaining portion 111A obtains the predetermined quantization table. This is the same as the operation of quantization table obtaining portion 111. Quantization table obtaining portion 111A provides the obtained first quantization table to adjuster 113A and quantizer 103. Thus, quantizer 103 receives the first quantization table, and therefore performs the quantization using the first quantization table. Data buffer 109 stores the first quantization table as the quantization table to be used for the quantization.

Adjuster 113A is connected to conversion table producing portion 117 and quantization table obtaining portion 111A. It receives the conversion table from conversion table producing portion 117, and receives the first quantization table from quantization table obtaining portion 111A. Adjuster 113A adjusts the table values by applying the conversion table to the first quantization table, and thereby produces the third quantization table. Adjuster 113A produces the third quantization table in contrast to adjuster 113 producing the second quantization table. Adjuster 113 A provides the third quantization table produced thereby to replacing portion 1107A. The third quantization table is used when dequantizing the entropy-decoded frequency image data in the processing of decompressing the compressed data.

The respective elements in the third quantization table produced by adjuster 113A take the values obtained by multiplying the corresponding element values in the first quantization table by the element values of the conversion table, respectively. More specifically, adjuster 113A calculates (Q3(i, j)=Q1(i, j)·F(i, j)) where array Q3(i, j) represents the array of respective elements in the third quantization table. It is preferable that all elements Q3(i, j) in the third quantization table are integers, and the results of division are changed into integers, e.g., by discarding all digits to the right of the decimal point, rounding off to the nearest integer or rounding up to the integer. Theoretically, it is preferable to obtain the integers by rounding off to the integer.

Replacing portion 1107A is connected to adjuster 113A and data buffer 109. Replacing portion 1107A receives the quantization table to be used for the dequantization from adjuster 113A. Replacing portion 1107A reads the quantization table used for the quantization, code table and code data from data buffer 109, and replaces the quantization table used for the quantization with the quantization table to be used for the dequantization. In this embodiment, it replaces the first quantization table stored in data buffer 109 with the third quantization table provided from adjuster 113A.

Replacing portion 1107A outputs the third quantization table, code table and code data. More specifically, replacing portion 1107A outputs the third quantization table to be used for the dequantization and the code data in the correlated fashion. The correlated fashion includes a case where the quantization table is added as a header to the code data, and these are output as one item of compressed data. Individual blocks may be correlated with the quantization table on a block-by-block basis. Also, groups each including the multiple blocks may be correlated with the quantization table on a group-by-group basis.

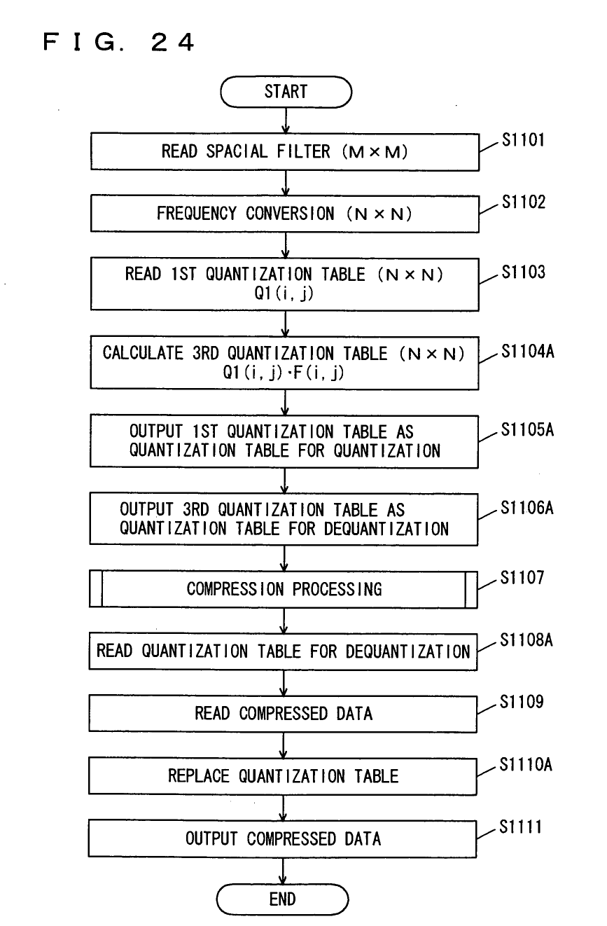

FIG. 24 is a flowchart illustrating flow of the image compression processing executed by the image compression device of the tenth embodiment. Referring to FIG. 24, the processing differs from the image compression processing executed by image compression device 10000 of the ninth embodiment in that steps S1104A and S1105A, S1106A, S1108A and S1110A are executed. Description will now be primarily given on the differences in processing.

In step S1104A, the first quantization table (N×N) read in step S1103 is adjusted using the conversion table (N×N) produced in step S1102, and thereby the third quantization table described with reference to FIG. 11 is produced. For the sake of illustration, the respective elements in the first quantization table are represented by array Q1(i, j), and the respective elements in the conversion table are represented by array F(i, j). The respective elements Q3(i, j) in the third quantization table are calculated by Q1(i, j)·F(i, j). Variables i and j represent the element positions in the longitudinal direction (row direction) and the lateral direction (column direction), respectively, and the relationships of (1≦i≦N,1≦j≦N) are satisfied when each of variables i and j starts from “1”, where i and j are integers.

In step S1105A, the first quantization table read in step S1103 is output as the quantization table for the quantization. In step S1106A, the third quantization table calculated in step S1104A is output as the quantization table for dequantization. The first and third quantization tables are output to the semiconductor memory such as a RAM arranged in image compression device 10000A.

In next step S1107, the compression processing illustrated in FIG. 22 is executed. When this compression processing is executed, data buffer 109 stores the first quantization table used for the quantization by quantizer 103 as well as the code table and the code data used for encoding by entropy encoder 105.

In step S1108A, the third quantization table for dequantization stored in step S1106A is read. In next step S1109, processing is performed to read the compressed data stored in data buffer 109, i.e., the first quantization table as well as the code table and the code data used for encoding by entropy encoder 105. The first quantization table used for the quantization in the compressed data thus read is replaced with the third quantization table for dequantization read in step S1108A (step S1110A). In step S1110A, since the quantization table is replaced, the format of the compressed data does not change. In step S1111, the compressed data in which the quantization table is replaced is output.

In image compression device 10000A according to the tenth embodiment, as described above, quantization table producing portion 110A obtains the first quantization table, and provides it as the quantization table to be used for the quantization to quantizer 103. Also, quantization table producing portion 1110A produces the third quantization table for use in the dequantization by adjusting the first quantization table, using the spatial filter, and provides it to replacing portion 1107A. Therefore, by determining the number (nine) of the elements in the spatial filter, it is possible to determine the first quantization table for the quantization and the third quantization table for the dequantization. It is possible to produce readily the first quantization table to be used for the quantization in the compression processing and the third quantization table to be used for the dequantization in the decompression processing.

Adjuster 113A produces the third quantization table to be used for the dequantization by adjusting the quantization table to be used for the quantization, using the spatial filter. Therefore, the image prepared by decompressing the compressed data is substantially the same as an image that is subjected to image processing using the spatial filter so that the spatial filtering processing is not required in the course of compression or decompression processing.

In particular, when the smoothing filter is used as the spatial filter, it is possible to reduce noises (e.g., mosquito noises) that are caused by a quantization error occurring in the quantization processing by quantizer 103.

Further, conversion table producing portion 117 produces the conversion table by performing the frequency conversion on the spatial filter, and adjuster 113A multiplies the elements in the quantization table by the corresponding elements in the conversion table. Therefore, the third quantization table can be readily obtained.

When it is difficult to change the structure of image compression device 10000A, such a configuration may be employed that the filtering processing can be executed only on the decompression device side.

Quantization table storing portion 120A stores the foregoing first quantization table and the foregoing third quantization table that is produced in advance by the foregoing processing of quantization table producing portion 1110A, and particularly stores these tables in the correlated fashion.

The processing in this embodiment can also be executed using the first and third quantization tables stored in quantization table storing portion 120A.

In this case, frequency converter 101 first performs the frequency conversion on the input image data. Then, quantizer 103 quantizes the data subjected to the frequency conversion by frequency converter 101, using the first quantization table stored in quantization table storing portion 120A. Quantizer 103 stores the first quantization table in data buffer 109.

Then, entropy encoder 105 performs entropy encoding on the quantized data produced by quantizer 103. Entropy encoder 105 stores the entropy-encoded code data in data buffer 109 in a fashion correlated with the first quantization table.

Then, replacing portion 1107A replaces the first quantization table correlated with the encoded code data by data buffer 109 with the third quantization table stored in quantization table storing portion 120A.

### Eleventh Embodiment

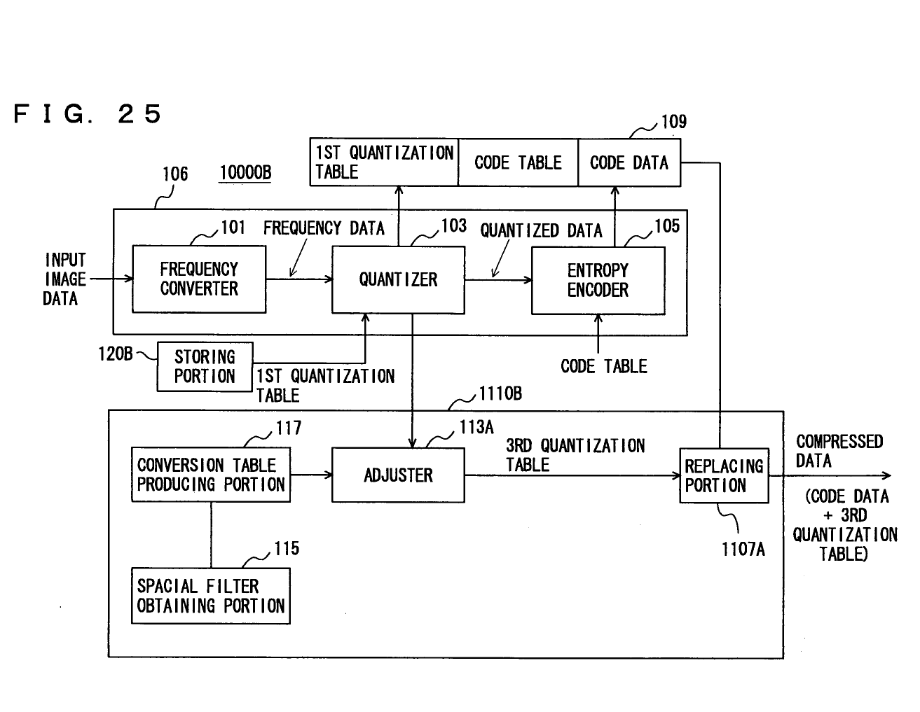

FIG. 25 is a functional block diagram illustrating a schematic structure of an image compression device according to an eleventh embodiment of the invention. Referring to FIG. 25, an image compression device 10000B according to the eleventh embodiment is the same as image compression device 10000A according to the tenth embodiment except for that quantization table obtaining portion 111A is not employed, quantization table storing portion 120B is employed instead of quantization table storing portion 120A and adjuster 113A receives the first quantization table from quantizer 103. Quantization table storing portion 120B stores in advance the first quantization table. Description will now be primarily given on the differences.

Quantizer 103 receives the first quantization table from quantization table storing portion 120B. Since quantizer 103 receives the first quantization table, it performs the quantization using the first quantization table. Quantizer 103 provides the first quantization table used for the quantization to adjuster 113A.

Adjuster 113A is connected to conversion table producing portion 117 and quantizer 103. It receives the conversion table from conversion table producing portion 117, and receives the first quantization table from quantizer 103. Adjuster 113A adjusts the table values by applying the conversion table to the first quantization table, and thereby produces the third quantization table. Adjuster 113A provides the third quantization table produced thereby to replacing portion 1107A. The third quantization table is used when dequantizing the entropy-decoded frequency image data in the processing of decompressing the compressed data.

In image compression device 10000B according to the eleventh embodiment, as described above, a quantization table producing portion 1110B obtains the first quantization table from the quantizer 103, produces the third quantization table to be used for the dequantization by adjusting the first quantization table, using the spatial filter, and provides it to replacing portion 1107A. Therefore, even when the quantization table to be used for the quantization by quantizer 103 is different from the quantization table that is actually provided to quantizer 103, it is possible to produce the third quantization table by adjusting the first quantization table used for the quantization. For example, the above is the case where quantizer 103 uses, for quantization, the quantization table produced, e.g., by multiplying the input quantization table by a predetermined factor.

The eleventh embodiment may employ such a manner that conversion table producing portion 117 converts the spatial filter obtained by spatial filter obtaining portion 115 to provide a conversion table, and the conversion table thus prepared is stored in advance. In this case, the stored conversion table is read without executing steps S1101-S1102 in the image compression processing illustrated in FIG. 24.

### Twelfth Embodiment

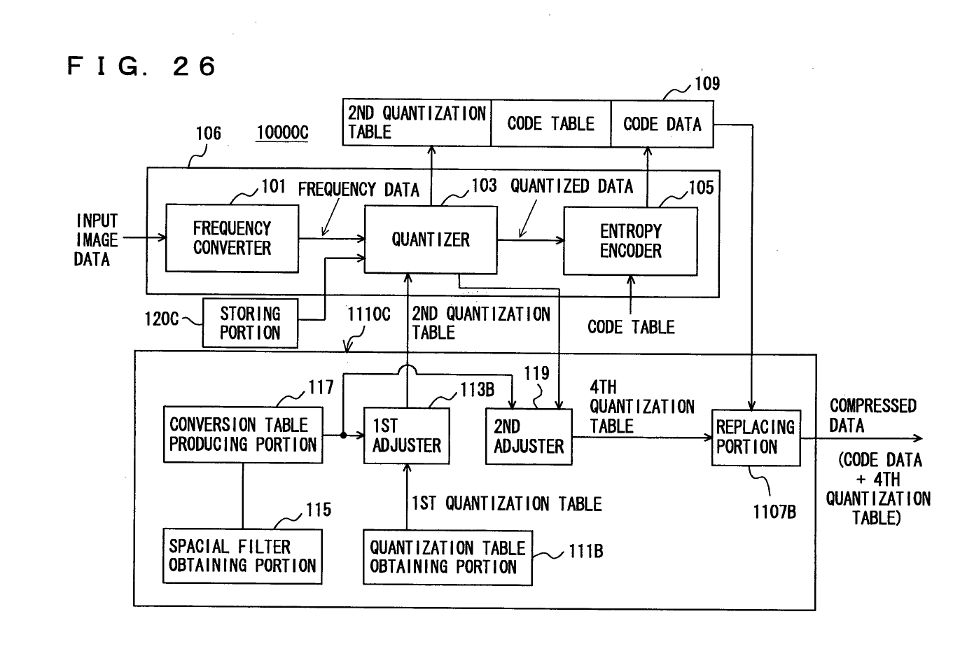

FIG. 26 is a functional block diagram illustrating a schematic structure of an image compression device according to a twelfth embodiment of the invention. Referring to FIG. 26, an image compression device 10000C according to the twelfth embodiment is the same as image compression device 10000 according to the ninth embodiment except for quantization table obtaining portion 111B, first adjuster 113B, second adjuster 119 and a replacing portion 1107B in a quantization table producing portion 1110C as well as quantization table storing portion 120C. Description will now be primarily given on the differences.

Quantization table obtaining portion 111B obtains a predetermined quantization table. This is the same as the operation of quantization table obtaining portion 111. Quantization table obtaining portion 111B provides the obtained first quantization table only to first adjuster 113B.

First adjuster 113B is connected to conversion table producing portion 117 and quantization table obtaining portion 111B. It receives the conversion table from conversion table producing portion 117, and receives the first quantization table from quantization table obtaining portion 111B. First adjuster 113B adjusts the table values by applying the conversion table to the first quantization table, and thereby produces the second quantization table. This operation is the same as that of adjuster 113. First adjuster 113B provides the second quantization table in which the respective elements are obtained by dividing the corresponding element values in the first quantization table by the element values in the conversion table, respectively. More specifically, first adjuster 113B calculates (Q2(i, j)=Q1(i, j)/F(i, j)) where Q1(i, j) represents the first quantization table, Q2(i, j) represents the second quantization table and F(i, j) represents the conversion table. It is preferable that all elements Q2(i, j) in the second quantization table are integers, and the results of division are changed into integers, e.g., by discarding all digits to the right of the decimal point, rounding off to the nearest integer or rounding up to the integer. Theoretically, it is preferable to obtain the integers by rounding off to the integer. First adjuster 113B provides the second quantization table thus produced to quantizer 103.

First adjuster 113B produces the second quantization table to be used for the quantization by quantizer 103, and provides it to quantizer 103. Therefore, quantizer 103 performs the quantization using the second quantization table.

Second adjuster 119 is connected to conversion table producing portion 117 and quantizer 103. It receives the conversion table from conversion table producing portion 117, and receives the second quantization table used for the quantization from quantizer 103. Second adjuster 119 adjusts the table values by applying the conversion table to the second quantization table, and thereby produces the fourth quantization table. The fourth quantization table is used for dequantizing the frequency image data subjected to the entropy decoding in the process of decompressing the compressed data.

Adjustment by second adjuster 119 provides the fourth quantization table in which the respective elements are obtained by multiplying the corresponding element values in the second quantization table by the element values in the conversion table, respectively. More specifically, second adjuster 119 calculates (Q4(i, j)=Q2(i, j)·F(i, J)) where Q4(i, j) represents the array of respective elements in the fourth quantization table. It is preferable that all elements Q4(i, j) in the fourth quantization table are integers, and each result of multiplication is changed into the integer, e.g., by discarding all digits to the right of the decimal point, rounding off to the nearest integer or rounding up to the integer. Theoretically, it is preferable to obtain the integers by rounding off to the integer.

Second adjuster 119 provides the fourth quantization table thus produced to replacing portion 1107B. Second adjuster 119 produces the fourth quantization table to be used for the dequantization, and provides it to replacing portion 11 07B.

Replacing portion 1107B is connected to second adjuster 119 and data buffer 109. Replacing portion 1107B receives the quantization table to be used for the dequantization from second adjuster 119. Replacing portion 1107B reads the quantization table used for the quantization, code table and code data from data buffer 109, and replaces the quantization table used for the quantization with the quantization table to be used for the dequantization. In this embodiment, it replaces the second quantization table stored in data buffer 109 with the fourth quantization table provided from second adjuster 119.

Replacing portion 1107B outputs the fourth quantization table, code table and code data. More specifically, replacing portion 1107B outputs the fourth quantization table to be used for the dequantization and the code data in the correlated fashion. The correlated fashion includes a case where the quantization table is added as a header to the code data, and these are output as one item of compressed data. Individual blocks may be correlated with the quantization table on a block-by-block basis. Also, groups each including the multiple blocks may be correlated with the quantization table on a group-by-group basis.

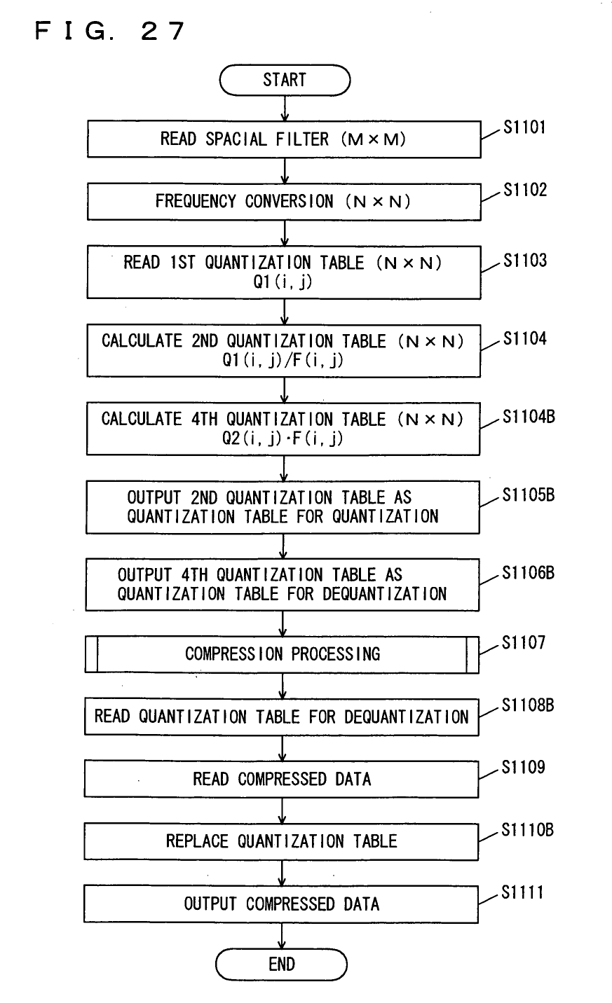

FIG. 27 is a flowchart illustrating flow of the image compression processing executed by the image compression device of the twelfth embodiment. Referring to FIG. 27, the processing differs from the image compression processing executed by image compression device 10000 of the ninth embodiment in that step 1104B is added after step S1104, and steps S1105B, S1106B, S1108B and S1110B are changed. Description will now be primarily given on the differences in processing.

In step S1104B, the second quantization table (N×N) calculated in step S1104 is adjusted using the conversion table (N×N) produced in step S1102, and thereby the fourth quantization table is produced. For the sake of illustration, the respective elements in the second quantization table are represented by array Q2(i, j), and the respective elements in the conversion table are represented by array F(i, j). The respective elements Q4(i, j) in the fourth quantization table are calculated by Q2(i, j)·F(i, j). Variables i and j represent the element positions in the longitudinal direction (row direction) and the lateral direction (column direction), respectively, and the relationships of (1≦i≦N, 1≦j≦N) are satisfied when each of variables i and j starts from “1”where i and j are integers.

In step S1105B, the second quantization table calculated in step S1104 is output as the quantization table for the quantization. In step S1106B, the fourth quantization table calculated in step S1104B is output as the quantization table for dequantization. The second and fourth quantization tables are output to the semiconductor memory such as a RAM arranged in image compression device 10000C.

In next step S1107, the compression processing illustrated in FIG. 22 is executed. When this compression processing is executed, data buffer 109 stores the second quantization table used for the quantization by quantizer 103 as well as the code table and the code data used for encoding by entropy encoder 105.

In step S1108B, the fourth quantization table for dequantization stored in step S1106B is read. In next step S1109, processing is performed to read the compressed data stored in data buffer 109, i.e., the second quantization table as well as the code table and the code data used for encoding by entropy encoder 105. The second quantization table used for the quantization in the compressed data thus read is replaced with the fourth quantization table for dequantization read in step S1108B (step S110B). In step S1110B, since the quantization table is replaced, the format of the compressed data does not change. In step S1111, the compressed data in which the quantization table is replaced is output.

In image compression device 10000C according to the twelfth embodiment, as described above, quantization table producing portion 1110C produces the second quantization table to be used for the quantization by adjusting the first quantization table, using the spatial filter, and provides the second quantization table thus produced to quantizer 103. Also, quantization table producing portion 1110C produces the fourth quantization table for use in the dequantization by adjusting the second quantization table, using the spatial filter, and provides it to replacing portion 1107B. Therefore, by determining the value of the number (nine) of the elements in the spatial filter, it is possible to determine the second quantization table for the quantization and the fourth dequantization table for the dequantization. It is possible to produce readily the second quantization table to be used for the quantization in the compression processing and the fourth quantization table to be used for the dequantization in the decompression processing.

Second adjuster 119 produces the fourth quantization table by adjusting the quantization table used for the quantization, using the spatial filter. Therefore, even when the quantization table to be used for the quantization by quantizer 103 is different from the second quantization table that is produced by first adjuster 113B and is provided to quantizer 103, it is possible to produce the fourth quantization table by adjusting the quantization table used for the quantization. For example, the above is the case where quantizer 103 uses, for quantization, the quantization table produced, e.g., by multiplying the input second quantization table by a predetermined factor.

When the smoothing filter is used as the spatial filter, it is possible to reduce noises (e.g., mosquito noises) that are caused by a quantization error occurring in the quantization processing by quantizer 103.

Further, conversion table producing portion 117 produces the conversion table by performing the frequency conversion on the spatial filter, and first adjuster 113B divides the elements in the first quantization table by the corresponding elements in the conversion table. Therefore, the second quantization table can be readily obtained. Since second adjuster 119 multiplies the elements in the second quantization table by the corresponding elements in the conversion table, the fourth quantization table can be readily obtained.

The twelfth embodiment may employ such a manner that conversion table producing portion 117 converts the spatial filter obtained by spatial filter obtaining portion 115 to provide a conversion table, and the conversion table thus prepared is stored in advance. In this case, the stored conversion table is read without executing steps S1101 and S1102 in the image compression processing illustrated in FIG. 27.

Quantization table storing portion 120C has stored the second quantization table that is produced in advance by adjusting the first quantization table by first adjuster 113B using the spatial filter.

The processing in this embodiment can also be executed using the second quantization table stored in quantization table storing portion 120C.

In this case, frequency converter 101 first performs the frequency conversion on the input image data. Then, quantizer 103 quantizes the data subjected to the frequency conversion by frequency converter 101, using the second quantization table stored in quantization table storing portion 120C. Quantizer 103 stores the second quantization table in data buffer 109.

Then, entropy encoder 105 performs entropy encoding on the quantized data produced by quantizer 103. Entropy encoder 105 stores the entropy-encoded code data in data buffer 109 in a fashion correlated with the second quantization table. Second adjuster 119 adjusts the table values by effecting on the second quantization table used for the quantization, using the spatial filter, and thereby produces the fourth quantization table for use in the dequantization.

Replacing portion 1107B replaces the second quantization table correlated to the encoded code data by data buffer 109 with the fourth quantization table.

In this case, the conversion table and the second quantization table that are stored in advance are read without executing steps S1101-S1104 in the image compression processing in FIG. 27.

Description has been given with reference to the flowcharts that are illustrated by way of example. The orders of processing are not restricted to those already described, and can be flexibly changed provided that such changes are made within a range of the spirit of the invention.

Although the present invention has been described and illustrated in detail, it is clearly understood that the same is by way of illustration and example only and is not to be taken by way of limitation, the spirit and scope of the present invention being limited only by the terms of the appended claims.

1. An image compression device comprising:
a quantization table storing portion storing a first quantization table and a second quantization table prepared by adjusting said first quantization table with a spatial filter;
a frequency converter performing frequency conversion on input image data;
a quantizer quantizing the data subjected to said frequency conversion, using said second quantization table;
an encoder encoding said quantized data; and
an output portion outputting said encoded data and said first quantization table in a correlated fashion.

2. An image compression device comprising:
a quantization table storing portion storing a first quantization table and a third quantization table prepared by adjusting said first quantization table with a spatial filter;
a frequency converter performing frequency conversion on input image data;
a quantizer quantizing the data subjected to said frequency conversion, using said first quantization table;
an encoder encoding said quantized data; and
an output portion outputting said encoded data and said third quantization table in a correlated fashion.

3. An image compression device comprising:
a quantization table storing portion storing a first quantization table;
a frequency converter performing frequency conversion on input image data;
a quantizer quantizing said frequency-converted data, using the first quantization table;
an encoder encoding said quantized data;
an adjuster producing a third quantization table by adjusting the first quantization table used for said quantization, using a spatial filter; and
an output portion outputting said encoded data and said third quantization table in a correlated fashion.

4. An image compression device comprising:
a quantization table storing portion storing a second quantization table prepared by adjusting a first quantization table with a spatial filter;
a frequency converter performing frequency conversion on input image data;
a quantizer quantizing said frequency-converted data, using said second quantization table;
an adjuster producing a fourth quantization table by adjusting the second quantization table used for said quantization, using said spatial filter;
an encoder encoding said quantized data; and
an output portion outputting said encoded data and said fourth quantization table in a correlated fashion.

5. An image compression device comprising:
a frequency converter performing frequency conversion on input image data;
a quantizer quantizing said frequency-converted data, using a quantization table given to the quantizer;
an encoder encoding said quantized data;
a correlating portion correlating said encoded code data with the quantization table used by said quantizer;
a quantization table storing portion storing a first quantization table and a second quantization table prepared by adjusting said first quantization table with a spatial filter,
said stored second quantization table being applied to said quantizer; and
a replacing portion replacing said second quantization table correlated with said encoded code data by said correlating portion with said stored first quantization table.

6. The image compression device according to claim 5, wherein
said spatial filter is one of a smoothing filter for smoothing an image, a sharpening filter for sharpening, or an edge enhancing filter for enhancing an edge.

7. An image compression device comprising:
a frequency converter performing frequency conversion on input image data;
a quantizer quantizing said frequency-converted data, using a quantization table given to said quantizer;
an encoder encoding said quantized data;
a correlating portion correlating said encoded code data with the quantization table used by said quantizer;
a quantization table storing portion storing a first quantization table and a third quantization table prepared by adjusting said first quantization table with a spatial filter,
said stored first quantization table being applied to said quantizer; and
a replacing portion replacing said first quantization table correlated with said encoded code data by said correlating portion with a third quantization table.

8. The image compression device according to claim 7, wherein
said spatial filter is one of a smoothing filter for smoothing an image, a sharpening filter for sharpening, or an edge enhancing filter for enhancing an edge.

9. An image compression device comprising:
a quantization table storing portion storing a first quantization table;
a frequency converter performing frequency conversion on input image data;
a quantizer quantizing said frequency-converted data, using a quantization table given to the quantizer;
an encoder encoding said quantized data;
a correlating portion correlating said encoded code data with the quantization table used by said quantizer,
said first quantization table being given to said quantizer;
an adjuster producing a third quantization table by adjusting the first quantization table used for said quantization, using a spatial filter; and
a replacing portion replacing said first quantization table correlated with said encoded code data by said correlating portion with said produced third quantization table.

10. The image compression device according to claim 9, wherein
said spatial filter is one of a smoothing filter for smoothing an image, a sharpening filter for sharpening, or an edge enhancing filter for enhancing an edge.

11. The image compression device according to claim 9, further comprising:
a conversion table producing portion producing a conversion table by performing frequency conversion on said spatial filter, wherein
said adjuster performs arithmetic on corresponding elements in said quantization table and said produced conversion table according to a predetermined rule.

12. An image compression device comprising:
a frequency converter performing frequency conversion on input image data;
a quantizer quantizing said frequency-converted data, using a quantization table given to said quantizer;
an encoder encoding said quantized data;
a correlating portion correlating said encoded code data with the quantization table used by said quantizer;
a quantization table storing portion storing a second quantization table prepared by adjusting a first quantization table with a spatial filter,
said stored second quantization table being applied to said quantizer;
an adjuster producing a fourth quantization table by adjusting the second quantization table used for said quantization, using said spatial filter; and
a replacing portion replacing said second quantization table correlated with said encoded code data by said correlating portion with the fourth quantization table.

13. The image compression device according to claim 12, wherein
said spatial filter is one of a smoothing filter for smoothing an image, a sharpening filter for sharpening, or an edge enhancing filter for enhancing an edge.

14. The image compression device according to claim 12, further comprising:
a conversion table producing portion producing a conversion table by performing frequency conversion on said spatial filter, wherein
said adjuster performs arithmetic on corresponding elements in said quantization table and said produced conversion table according to a predetermined rule.

15. An image compression method executed by an image compression device including:
a frequency converter performing frequency conversion on input image data;
a quantizer quantizing said frequency-converted data, using a quantization table given to the quantizer;
an encoder encoding said quantized data;
a correlating portion correlating said encoded code data with the quantization table used by said quantizer; and
a quantization table storing portion storing a first quantization table and a second quantization table prepared by adjusting said first quantization table with a spatial filter, wherein said method comprising the steps of:
giving said stored second quantization table to said quantizer; and
replacing said second quantization table correlated with said encoded code data by said correlating portion with said stored first quantization table.

16. An image compression method executed by an image compression device including:
a frequency converter performing frequency conversion on input image data;
a quantizer quantizing said frequency-converted data, using a quantization table given to said quantizer;
an encoder encoding said quantized data;
a correlating portion correlating said encoded code data with the quantization table used by said quantizer; and
a quantization table storing portion storing a first quantization table and a third quantization table prepared by adjusting said first quantization table with a spatial filter, wherein
said method comprising the steps of:
giving said stored first quantization table to said quantizer; and
replacing said first quantization table correlated with said encoded code data by said correlating portion with said stored third quantization table.

17. An image compression method executed by an image compression device including:
a quantization table storing portion storing a first quantization table;
a frequency converter performing frequency conversion on input image data;
a quantizer quantizing said frequency-converted data, using a quantization table given to the quantizer;
an encoder encoding said quantized data; and
a correlating portion correlating said encoded code data with the quantization table used by said quantizer, wherein
said method comprising the steps of:
giving the first quantization table to said quantizer;
producing a third quantization table by adjusting the first quantization table used for said quantization, using a spatial filter; and
replacing said first quantization table correlated with said encoded code data by said correlating portion with the produced third quantization table.

18. An image compression method executed by an image compression device including:
a frequency converter performing frequency conversion on input image data;
a quantizer quantizing said frequency-converted data, using a quantization table given to the quantizer;
an encoder encoding said quantized data;
a correlating portion correlating said encoded code data with the quantization table used by said quantizer; and
a quantization table storing portion storing a second quantization table prepared by adjusting the first quantization table, using the spatial filter, wherein
said method comprising the steps of:
giving said stored second quantization table to said quantizer;
producing a fourth quantization table by adjusting said second quantization table used for said quantization, using said spatial filter; and
replacing said second quantization table correlated with said encoded code data by said correlating portion with said produced fourth quantization table.

19. An image compression program product for execution by a computer including:
a frequency converter performing frequency conversion on input image data;
a quantizer quantizing said frequency-converted data, using a quantization table given to the quantizer;
an encoder encoding said quantized data;
a correlating portion correlating said encoded code data with the quantization table used by said quantizer; and
a quantization table storing portion storing a first quantization table and a second quantization table prepared by adjusting said first quantization table with a spatial filter, wherein
said image compression program product causing a computer to execute the steps of:
giving said stored second quantization table to said quantizer; and
replacing said second quantization table correlated with said encoded code data by said correlating portion with said stored first quantization table.

20. An image compression program product for execution by a computer including:
a frequency converter performing frequency conversion on input image data;
a quantizer quantizing said frequency-converted data, using a quantization table given to said quantizer;
an encoder encoding said quantized data;
a correlating portion correlating said encoded code data with the quantization table used by said quantizer; and
a quantization table storing portion storing a first quantization table and a third quantization table prepared by adjusting said first quantization table with a spatial filter, wherein
said image compression program product causing a computer to execute the steps of:
giving said stored first quantization table to said quantizer; and
replacing said first quantization table correlated with said encoded code data by said correlating portion with said stored third quantization table.

21. An image compression program product for execution by a computer including:
a quantization table storing portion storing a first quantization table;
a frequency converter performing frequency conversion on input image data;
a quantizer quantizing said frequency-converted data, using a quantization table given to the quantizer;
an encoder encoding said quantized data; and
a correlating portion correlating said encoded code data with the quantization table used by said quantizer, wherein
said image compression program product causing a computer to execute the steps of:
giving the first quantization table to said quantizer;
producing a third quantization table by adjusting the first quantization table used for said quantization, using a spatial filter; and
replacing said first quantization table correlated with said encoded code data by said correlating portion with the produced third quantization table.

22. An image compression program product for execution by a computer including:
a frequency converter performing frequency conversion on input image data;
a quantizer quantizing said frequency-converted data, using a quantization table given to the quantizer;
an encoder encoding said quantized data;
a correlating portion correlating said encoded code data with the quantization table used by said quantizer; and
a quantization table storing portion storing a second quantization table prepared by adjusting the first quantization table, using the spatial filter, wherein
said image compression program product causing a computer to execute the steps of:
giving said stored second quantization table to said quantizer;
producing a fourth quantization table by adjusting said second quantization table used for said quantization, using said spatial filter; and
replacing said second quantization table correlated with said encoded code data by said correlating portion with said produced fourth quantization table.

23. A quantization table producing device comprising:
a quantization table obtaining portion obtaining a quantization table and outputting the obtained quantization table as a quantization table to be used for dequantization;
a spatial filter obtaining portion obtaining a spatial filter; and
an adjuster producing a quantization table to be used for quantization by adjusting said obtained quantization table, using said obtained spatial filter.

24. The quantization table producing device according to claim 23, wherein said spatial filter is one of a smoothing filter for smoothing an image, a sharpening filter for sharpening, or an edge enhancing filter for enhancing an edge.

25. The quantization table producing device according to claim 23, further comprising:
a conversion table producing portion producing a conversion table by performing frequency conversion on said spatial filter, wherein
said adjuster performs arithmetic on corresponding elements in said quantization table and said produced conversion table according to a predetermined rule.

26. A quantization table producing device comprising:
a quantization table obtaining portion obtaining a quantization table and outputting the obtained quantization table as a quantization table to be used for quantization;
a spatial filter obtaining portion obtaining a spatial filter; and
an adjuster producing a quantization table to be used for dequantization by adjusting said obtained quantization table, using said obtained spatial filter.

27. The quantization table producing device according to claim 26, wherein
said spatial filter is one of a smoothing filter for smoothing an image, a sharpening filter for sharpening, or an edge enhancing filter for enhancing an edge.

28. The quantization table producing device according to claim 26, further comprising:
a conversion table producing portion (producing a conversion table by performing frequency conversion on said spatial filter, wherein
said adjuster performs arithmetic on corresponding elements in said quantization table and said produced conversion table according to a predetermined rule.

29. A quantization table producing device comprising:
a spatial filter obtaining portion obtaining a spatial filter; and
an adjuster producing a quantization table to be used for dequantization by adjusting the quantization table used for quantization, using said obtained spatial filter.

30. The quantization table producing device according to claim 29, wherein
said spatial filter is one of a smoothing filter for smoothing an image, a sharpening filter for sharpening, or an edge enhancing filter for enhancing an edge.

31. The quantization table producing device according to claim 29, further comprising:
a conversion table producing portion producing a conversion table by performing frequency conversion on said spatial filter, wherein
said adjuster performs arithmetic on corresponding elements in said quantization table and said produced conversion table according to a predetermined rule.

32. A quantization table producing device comprising:
a quantization table obtaining portion obtaining a quantization table;
a spatial filter obtaining portion obtaining a spatial filter;
a first adjuster producing a quantization table to be used for quantization by adjusting said obtained quantization table, using said obtained spatial filter; and
a second adjuster producing a quantization table to be used for dequantization by adjusting the quantization table used for quantization, using said obtained spatial filter.

33. The quantization table producing device according to claim 32, wherein
said spatial filter is one of a smoothing filter for smoothing an image, a sharpening filter for sharpening, or an edge enhancing filter for enhancing an edge.

34. The quantization table producing device according to claim 32, further comprising:
a conversion table producing portion producing a conversion table by performing frequency conversion on said spatial filter, wherein
said first and second adjusters perform arithmetic on corresponding elements in said quantization table and said produced conversion table according to a predetermined rule.

35. An image compression device comprising:
a quantization table obtaining portion obtaining a quantization table and outputting the obtained quantization table as a quantization table to be used for dequantization;
a spatial filter obtaining portion obtaining a spatial filter;
an adjuster producing a quantization table to be used for quantization by adjusting said obtained quantization table, using said obtained spatial filter;
a frequency converter performing frequency conversion on input image data;
a quantizer receiving the quantization table used for quantization, and quantizing said frequency-converted data, using the received quantization table;
an encoder encoding said quantized data; and
an output portion receiving the quantization table to be used for said dequantization, and outputting said encoded code data and the received quantization table to be used for dequantization in a correlated fashion.

36. An image compression device comprising:
a quantization table obtaining portion obtaining a quantization table and outputting the obtained quantization table as a quantization table to be used for quantization;
a spatial filter obtaining portion obtaining a spatial filter;
an adjuster producing a quantization table to be used for dequantization by adjusting said obtained quantization table, using said obtained spatial filter;
a frequency converter performing frequency conversion on input image data;
a quantizer receiving the quantization table used for quantization, and quantizing said frequency-converted data, using the received quantization table;
an encoder encoding said quantized data; and
an output portion receiving the quantization table to be used for said dequantization, and outputting said encoded code data and the received quantization table to be used for dequantization in a correlated fashion.

37. An image compression device comprising:
a spatial filter obtaining portion obtaining a spatial filter;
an adjuster producing a quantization table to be used for dequantization by adjusting the quantization table used for quantization, using said obtained spatial filter;
a frequency converter performing frequency conversion on input image data;
a quantizer receiving the quantization table used for quantization, and quantizing said frequency-converted data, using the received quantization table;
an encoder encoding said quantized data; and
an output portion receiving the quantization table to be used for said dequantization, and outputting said encoded code data and the received quantization table to be used for dequantization in a correlated fashion.

38. An image compression device comprising:
a quantization table obtaining portion obtaining a quantization table;
a spatial filter obtaining portion obtaining a spatial filter;
a first adjuster producing a quantization table to be used for quantization by adjusting said obtained quantization table, using said obtained spatial filter;
a second adjuster producing a quantization table to be used for dequantization by adjusting the quantization table used for quantization, using said obtained spatial filter;
a frequency converter performing frequency conversion on input image data;
a quantizer receiving the quantization table to be used for quantization, and quantizing said frequency-converted data, using said received quantization table;
an encoder encoding said quantized data; and
an output portion receiving said quantization table to be used for dequantization, and outputting said encoded code data and said received quantization table to be used for dequantization in a correlated fashion.

39. A quantization table producing method comprising the steps of:
obtaining a quantization table and outputting the quantization table as a quantization table to be used for dequantization;
obtaining a spatial filter; and
producing a quantization table to be used for quantization by adjusting said obtained quantization table, using said obtained spatial filter.

40. A quantization table producing method comprising the steps of:
obtaining a quantization table and outputting the quantization table as a quantization table to be used for quantization;
obtaining a spatial filter; and
producing a quantization table to be used for dequantization by adjusting said obtained quantization table, using said obtained spatial filter.

41. A quantization table producing method comprising the steps of:
obtaining a spatial filter; and
producing a quantization table to be used for dequantization by adjusting a quantization table used for quantization, using said obtained spatial filter.

42. A quantization table producing method comprising the steps of:
obtaining a quantization table;
obtaining a spatial filter;
producing a quantization table to be used for quantization by adjusting said obtained quantization table, using said obtained spatial filter; and
producing a quantization table to be used for dequantization by adjusting a quantization table to be used for quantization, using said obtained spatial filter.

43. A quantization table producing program product causing a computer to execute the steps of:
obtaining a quantization table and outputting the quantization table as a quantization table to be used for dequantization;
obtaining a spatial filter; and
producing a quantization table to be used for quantization by adjusting said obtained quantization table, using said obtained spatial filter.

44. A quantization table producing program product causing a computer to execute the steps of:
obtaining a quantization table and outputting the quantization table as a quantization table to be used for quantization;
obtaining a spatial filter; and
producing a quantization table to be used for dequantization by adjusting said obtained quantization table, using said obtained spatial filter.

45. A quantization table producing program product causing a computer to execute the steps of:
obtaining a spatial filter; and
producing a quantization table to be used for dequantization by adjusting a quantization table used for quantization, using said obtained spatial filter.

46. A quantization table producing program product causing a computer to execute the steps of:
obtaining a quantization table;
obtaining a spatial filter;
producing a quantization table to be used for quantization by adjusting said obtained quantization table, using said obtained spatial filter; and
producing a quantization table to be used for dequantization by adjusting a quantization table to be used for quantization, using said obtained spatial filter.
